(19) United States
(12) Patent Application Publication
(10) Pub. No.: US 2017/0010429 A1
(43) Pub. Date: Jan. 12, 2017

(54) FLEXIBLE HYBRID CABLE AND METHODS OF MAKING AND USING SUCH

(71) Applicant: Chang Won PARK, Seongnam-si (KR)

(72) Inventor: Chang Won PARK, Seongnam-si (KR)

(21) Appl. No.: 15/056,321

(22) Filed: Feb. 29, 2016

Related U.S. Application Data
(60) Provisional application No. 62/189,535, filed on Jul. 7, 2015.

(51) Int. Cl. G02B 6/44; H01B 11/22

(52) U.S. Cl. CPC G02B 6/4416; G02B 6/4433; G02B 6/442; H01B 11/22

(57) ABSTRACT

The present invention relates to various flexible hybrid cables transmitting data through two or more different transmission mechanisms, e.g., one mechanism utilizing electromagnetic energy (e.g., lights), another mechanism utilizing electrical energy (e.g., electrical voltages or currents), and so on. More particularly, the present invention relates to the flexible hybrid cables incorporating various planar cable units so that such cables are elongated in their cross-sections, are rather flexible, and are more conveniently stored and installed. The present invention also relates to various methods of manufacturing the flexible hybrid cables, to various methods of using such flexible hybrid cables, and to various methods of incorporating conventional electrical cables (or optical fibers) thereinto.

### CROSS-REFERENCE TO RELATED APPLICATIONS

This application is a non-provisional of provisional U.S. Application No. 62/189,535, filed Jul. 7, 2015 in the U.S. Patent and Trademark Office. All disclosures of the document named above are incorporated herein by reference.

### BACKGROUND OF THE INVENTION

1. Field of the Invention

The present invention relates to a flexible hybrid cable which may typically transmit data through two or more different transmission mechanisms, e.g., one mechanism utilizing electromagnetic energy (e.g., lights), another mechanism utilizing electrical energy (e.g., electrical voltages or currents), and so on. Accordingly, one exemplary flexible hybrid cable may include at least one optical unit and at least one planar cable unit, where the exemplary optical unit includes at least one prior art optical fiber and where the exemplary planar cable unit includes at least one prior art electrically conductive path which is typically provided on at least one surface of a flat or curvilinear base. The present invention also relates to various methods of manufacturing the flexible hybrid cables, to various methods of using such flexible hybrid cables, various methods of incorporating conventional electrical cables (or conventional optical fibers) into various flexible hybrid cables of this invention, and the like.

2. Description of the Related Art

With the advent of information and internet technologies, users desire to transmit or receive data signals of a bigger size at a faster rate. Accordingly, the size of such data signals as well as the rates of data transmission almost always tends to surpass the available speed and reliability of transmitting or receiving data signals through prior art cables. To meet such needs, various combination cables became available in the market, e.g., by incorporating prior art optical fibers and prior art electrical cables thereinto, where the bigger data signals are transmitted at higher data transmission rates through the optical fibers of the combination cables, while the smaller data signals are transmitted at relatively lower data transmission rates through the electrical cables of the combination cables. However, the current combination cables are rather thick, expensive, not easy to bend, not easy to connect to prior art connectors, and the like. There is a need for better hybrid cables which may be thinner and cheaper than the prior art counterparts and, therefore, which may be easier to bend and more convenient to work with.

### SUMMARY OF THE INVENTION

The present invention relates to various flexible hybrid cables each of which typically includes at least one optical unit and at least one planar cable unit. The exemplary optical unit typically includes at least one conventional optical fiber, and the exemplary planar cable unit typically includes at least one conventional electrically conductive path which is typically provided on at least one surface of a flat (or at least partly curvilinear) base. The present invention also relates to various methods of manufacturing the flexible hybrid cables and to various methods of using such flexible hybrid cables.

Accordingly, various flexible hybrid cables of the present invention serve many different objectives and offer various benefits.

For example, the flexible hybrid cable of this invention offers the benefit of providing an enhanced flexibility so that a user can easily bend the flexible hybrid cable without damaging the optical and/or planar cable units thereof and without damaging the optical fibers and/or electrically conductive paths of the optical and planar cable units, respectively.

The flexible hybrid cable of this invention also offers the benefit of minimizing adverse effects from electromagnetic interference (to be referred to as “EMI” hereinafter) on the data signals transmitted therethrough, for the high-bandwidth data signals are solely (or predominantly) transmitted through the optical fibers of the optical unit which are not significantly affected by the EMI. Accordingly, the flexible hybrid cable of this invention offers the related benefit of low cost of fabrication, for the optical unit of the flexible hybrid cable does not need as much electrical insulation against the EMI as its conventional counterparts.

The flexible hybrid cable of this invention also offers the benefit of minimizing adverse effects from the EMI on the non-data signals transmitted therethrough, for the low-bandwidth non-data signals are solely (or predominantly) transmitted through the planar cable unit but such non-data signals are minimally affected by the EMI. Accordingly, the flexible hybrid cable of this invention also offers the related benefit of low cost of fabrication, for the planar cable unit of the flexible hybrid cable may need only minimal electrical insulation against the EMI as its conventional counterparts.

Due to the aforementioned benefits, the flexible hybrid cable of this invention also offers the benefit of transmitting the same quantity of data signals with an enhanced speed and with less distortion of such signals due to the reduced EMI.

The flexible hybrid cable of this invention also offers the benefit of providing enhanced convenience and freedom in storing and installing such. For example, by incorporating a flexible planar cable unit, the flexible hybrid cable can have an elongated cross-section. Accordingly, the flexible hybrid cable can be easily rolled, can exhibit mechanical resistance to axial bending, and the like.

Accordingly and in one exemplary aspect of this invention, a flexible hybrid cable comprises at least one optical unit, at least one planar cable unit, and at least one external cover. The optical unit may include at least one optical fiber and may transmit an optical signal along the optical fiber, while the planar cable unit may include at least one flexible planar substrate and at least one electrically conductive path disposed on the substrate and transmit an electrical signal along the conductive path. The external cover may encompass the optical unit and the planar cable unit therein.

In addition, the optical unit may include at least one plastic optical fiber, thereby adding flexibility to the optical unit as well as to the cable itself. The planar cable unit may define an elongated cross-sectional shape, while the cable may also define an elongated cross-section which in turn defines a short axis and a long axis. The ratio of the short axis to the long axis may be less than 0.9. In the alternative, such a ratio may be less than 0.8, 0.7, 0.6, 0.5, 0.4, 0.3, 0.2, 0.1, and the like.

The optical unit and the planar cable unit may be disposed at least partly laterally along the long axis. In one example, an entire portion of the optical unit and an entire portion of the planar cable unit may be disposed on different ends of the cable along the long axis. In another example, at least a portion of the optical unit may be disposed over or below at least a portion of the planar cable unit.

The optical unit may instead be at least partly stacked over or below the planar cable unit along the short axis. In one example, an entire portion of the optical unit (or planar cable unit) may be stacked over or below the planar cable unit (or optical unit). In another example, at least a portion of the optical unit (or planar cable unit) may not be stacked directly over or directly below the planar cable unit (or optical unit).

The flexible hybrid cable may be flexible enough to define a minimum bend diameter of about 20 times a diameter of the optical fiber, while not decreasing transmission ability of the optical fiber by about 10%. Alternatively, the flexible hybrid cable may be flexible enough to define a minimum bend diameter of about 10 mm, 7 mm, 5 mm, 4 mm, 3 mm or 2 mm, while not decreasing transmission ability of the optical fiber by about 10%.

The planar cable unit may include a single-sided planar cable, a double-access cable, a back bared planar cable, a sculptured planar cable, a double-sided planar cable, a multilayer planar cable, a rigid-flexible cable, a polymer film cable, and the like. The substrate of the planar cable unit may include a polymeric compound which may be polyimide, polyester, polyethylene napthalate, aramid, polyetherimide, polyether ether ketone, polyethylene terephthalate, various fluoro-polymers, epoxy, and the like.

The electrically conductive path may include at least one conductive metal. The conductive path may include at least one sitting portion which is shaped and sized to releasably or fixedly retain the optical fiber therein or thereon.

The flexible hybrid cable may further comprise a first coating disposed on top of the conductive path and mechanically or electrically protecting the path, a second coating disposed on one side of the conductive path and mechanically or electrically protecting the path, and the like. The flexible hybrid cable may further comprise a first cover enclosing therein at least a portion of the optical unit, a second cover enclosing therein at least a portion of the planar cable unit, and the like. The flexible hybrid cable may further comprise a first coupling unit coupling the optical unit to the planar cable unit, a second coupling unit coupling the first cover to the planar cable unit, a third coupling unit coupling the second cover to the optical unit, and the like. The flexible hybrid cable may further comprise a first insulator disposed between two electrically conductive paths for providing electrical insulation therebetween, a second insulator disposed between two planar cable units for providing electrical insulation therebetween, a third insulator disposed between the optical unit and planar cable unit for providing electrical insulation to the planar cable unit, and the like. The flexible hybrid cable may further comprise a first external filler to mechanically protect the optical and/or planar cable unit, a second external filler to protect the planar cable unit from electromagnetic interference, a third external filler to maintain an elongated shape of the cable, and the like.

In another exemplary aspect of this invention, a flexible hybrid cable may have an elongated cross-section and comprise multiple optical fibers, at least one planar cable unit, and at least one external cover. Each of the optical fibers may transmit an optical signal therealong, the planar cable unit may include at least one substrate and at least one electrically conductive path, and the external cover may encompass such optical fibers and planar cable unit therein. In addition, the substrate may be flexible and define an elongated cross-section, the electrically conductive path may be disposed on the substrate and transmit an electrical signal therealong, and the optical fibers may be arranged inside the external cover while maintaining the elongated cross-section of the cable. At least one of such optical fibers may be a plastic optical fiber, thereby adding flexibility to the cable.

The cross-section of the cable may define a short axis and a long axis, where a ratio of the short axis to the long axis may be less than 0.9. Alternatively, such a ratio may be less than 0.8, 0.7, 0.6, 0.5, 0.4, 0.3, 0.2, 0.1, and the like.

The flexible hybrid cable may be flexible enough to define a minimum bend diameter of about 20 times a diameter of the optical fiber, while not decreasing transmission ability of the optical fiber by about 10%. Alternatively, the flexible hybrid cable may be flexible enough to define a minimum bend diameter of about 10 mm, 7 mm, 5 mm, 4 mm, 3 mm or 2 mm, while not decreasing transmission ability of the optical fiber by about 10%.

The planar cable unit may include a single-sided planar cable, a double-access cable, a back bared planar cable, a sculptured planar cable, a double-sided planar cable, a multilayer planar cable, a rigid-flexible cable, a polymer film cable, and the like. The substrate of the planar cable unit may include a polymeric compound which may be polyimide, polyester, polyethylene napthalate, aramid, polyetherimide, polyether ether ketone, polyethylene terephthalate, various fluoro-polymers, epoxy, and the like.

The electrically conductive path may include at least one conductive metal. The conductive path may include at least one sitting portion which is shaped and sized to releasably or fixedly retain the optical fiber therein or thereon.

In another exemplary aspect of this invention, a flexible hybrid cable may include at least one optical unit, at least one planar cable unit, and at least one external cover. The optical unit may include at least one optical fiber and transmit an optical signal along the fiber, while the planar cable unit may include at least one flexible planar substrate and at least one electrically conductive path disposed on the substrate and may transmit an electrical signal along the electrically conductive path. The external cover may encompass the optical unit and planar cable unit therein, where the optical unit may be disposed next to, around, above or below the planar cable unit while maintaining the cable to define an elongated cross-section.

In another exemplary aspect of this invention, a flexible hybrid cable may include an external cover and the external cover may comprise therein at least one optical unit and at least one planar cable unit. Such a planar cable unit may include at least one flexible planar substrate and at least one electrically conductive path disposed on the substrate and may transmit an electrical signal along the electrically conductive path. The optical unit may be disposed in a predetermined arrangement with respect to the planar cable unit and may transmit an optical signal along the fiber, where the cable may define an elongated cross-section due to the above arrangement and/or a cross-section of the planar substrate.

In another exemplary aspect of this invention, a method may also be provided for transmitting a high-bandwidth signal and a low-bandwidth signal through a single cable while providing enhanced mechanical flexibility and flat structure to the cable. The method may include the steps of: optically transmitting the high-bandwidth signal along at least one flexible optical fiber included in the cable; forming at least one electrically conductive path on a planar and flexible substrate included in the cable; and electrically transmitting the low-bandwidth signal along the conductive path, thereby maintaining the flexibility of the cable and maintaining an elongated cross-section of the cable at least partly due to the flat structure of the substrate.

The optically transmitting step may include the step of: including at least one plastic optical fiber as the optical fiber, thereby adding such flexibility to the cable.

In the method, the cross-section of the cable may define a short axis and a long axis, where the step of such maintaining such cross-section of the cable may include at least one of the steps of: maintaining a ratio of the short axis to the long axis less than 0.9; maintaining the ratio less than 0.7; maintaining the ratio less than 0.5; maintaining the ratio less than 0.3; maintaining the ratio less than 0.1, and the like.

The method may comprise the step of: disposing the optical unit and the planar cable unit at least partly laterally along the long axis. The method may also comprise the step of: disposing an entire portion the optical unit and an entire portion of the planar cable unit on different ends of the cable along the long axis. The method may further comprise one of the steps of: disposing at least a portion of the optical unit over or above at least a portion of the planar cable unit; and disposing at least a portion of the optical unit under or below at least a portion of the planar cable unit.

The method may comprise the step of: at least partly stacking the optical unit over or below the planar cable unit along the short axis. The method may also comprise one of the steps of: stacking an entire portion of the optical unit over or above the planar cable unit; and stacking an entire portion of the optical unit under or below the planar cable unit. The method may also comprise one of the steps of: stacking at least a portion of the optical unit not directly over or not directly below the planar cable unit; and stacking at least a portion of the planar cable unit not directly over or not directly below the optical unit.

The method may further comprise at least one of the steps of: bending the cable with a minimum bend diameter of about 20 times a diameter of the optical fiber while not damaging transmission ability of the optical fiber by about 10%; and bending the cable with a minimum bend diameter of 7 mm, 5 mm, 3 mm or 1 mm while not damaging transmission ability of the optical fiber by about 10%.

The step of forming the conductive path may be one of: forming a single-sided planar cable; forming a double-access cable; forming a back bared planar cable; forming a sculptured planar cable; forming a double-sided planar cable; forming a multilayer planar cable; forming a rigid-flexible cable; and forming a polymer film cable.

The step of forming the path on the substrate may include at least one of the steps of: including polyimide in the substrate; including polyester in the substrate; including polyethylene napthalate in the substrate; including polyetherimide in the substrate; including polyether ether ketone in the substrate; including polyethylene terephthalate in the substrate; including fluoro-polymer in the substrate; including aramid in the substrate; and including epoxy in the substrate.

The method may further comprise at least one of the steps of: retaining at least a portion of the optical fiber by the substrate releasably or fixedly; retaining at least a portion of the substrate by the optical fiber releasably or fixedly; mechanically or electrically protecting the path with a coating; first enclosing at least a portion of the optical fiber for mechanical protection or for positioning of the fiber; second enclosing at least a portion of the substrate for mechanical protection or for positioning of the substrate; coupling at least a portion of the optical fiber to the substrate; and coupling the first enclosing to the second enclosing.

The method may further comprise at least one of the steps of: insulating the conductive path for electrical insulation; and insulating multiple conductive paths for electrical insulation therebetween.

The method may further comprise one of the steps of: filling at least a portion of an interior of the cable for mechanical protection of the optical fiber, substrate, and/or conductive path; filling at least a portion of the interior of the cable to protect the path from electromagnetic interference; and filling at least a portion of the interior of the cable to maintain the elongated cross-section of the cable.

Various system aspects and method aspects of the flexible hybrid cable of the present invention and various embodiments thereof are now enumerated. It is to be understood, however, that following flexible hybrid cables and/or methods of manufacturing such cables or using such cables of the present invention may be embodied in many other different forms and, accordingly, should not be limited to such aspects and/or their embodiments which are to be set forth herein. Rather, various exemplary aspects and their embodiments described hereinafter are provided such that this disclosure will be thorough and complete, and fully convey the scope of the present invention to one of ordinary skill in the relevant art.

As used herein, the “optical fiber” means a fiber which typically transmits light between its two ends. It is noted that, throughout this disclosure, the “optical fiber” means any conventional optical fibers. Therefore, the “optical fiber” may refer to a conventional glass optical fiber, a conventional polymer optical fiber (i.e., POF) and a hybrid thereof. The “optical fiber” may also refer to a conventional single-mode optical fiber or a conventional multiple-mode optical fiber. The “optical fiber” may also refer to a conventional optical fiber with a step-index profile or a conventional optical fiber with a graded-index profile. The “optical fiber” may further refer to a conventional micro-structured optical fiber.

As used herein, the term ‘flexible’ means a feature of an object capable of being bent, twisted, folded or otherwise deformable due to an external stress. Accordingly, throughout this disclosure, the “flexible object” means an object which can be bent, twisted, folded or otherwise deformed in a direction transverse to its length, width or thickness in response to the external stress. Such a “flexible object” may exhibit flexibility because it is made of and/or includes at least one flexible substance therein. Alternatively, the “flexible object” may exhibit such flexibility because its length or width far exceeds its thickness by, e.g., twice, 3 times, 5 times, 7 times, 10 times, 50 times, 100 times, 500 times, 1,000 times or more, even if such an object is made of and/or includes at least one rigid substance. Of course the “flexible object” made of and/or including the flexible substance may exhibit better flexibility than the one made and/or including the rigid substance.

As used herein, the term ‘planar’ means a feature of an object which is two-dimensional and may be flat, rugged, curved or otherwise curvilinear. Thus, throughout this disclosure, the “planar object” refers to any object which has a curvilinear length, a curvilinear width, and a curvilinear thickness, where its length and/or width far exceeds its thickness by, e.g., twice, 3 times, 5 times, 7 times, 10 times, 50 times, 100 times, 500 times, 1,000 times or more.

As used herein, the “planar cable (or planar circuit)” refers to a conventional electrical cable which defines or includes at least one electrically conductive path on or over a planar base (or substrate) along its length or width. Accordingly, throughout this disclosure, the “planar cable” may refer to a conventional planar printed cable with such a path(s), a conventional planar printed or laminated flat cable with such a path(s), a conventional planar foil cable with such a path(s), and other planar cables each of which may include at least one such path which is provided thereon or thereinto by various conventional methods such as, e.g., lithographic technology, photolithographic technology, laminating technology with or without using adhesives, and so on. Furthermore, the “planar cable” defines a curvilinear length, a curvilinear width, and a curvilinear thickness, where its length and/or width far exceeds its thickness by, e.g., twice, 3 times, 5 times, 7 times, 10 times, 30 times, 50 times, 100 times, 300 times, 500 times, 1,000 times or more.

The “planar cable” may be provided in various structures. One example is a “single-sided planar cable,” where the electrically conductive path(s) is provided on one surface of the substrate and, therefore, is accessible only from such a surface. Another example is a “double-access cable or back bared planar cable,” where the path(s) is provided on one surface of the surface but accessible from both surfaces. Another example is a “sculptured planar cable,” where the path(s) has a varying thickness along a length and/or a width of the substrate, e.g., the path(s) has a greater thickness at an interconnection point. Another example is a “double-sided planar cable,” where multiple electrically conductive paths are provided on both surfaces of the substrate. Accordingly, such a planar cable allows crossover connections between the paths provided on opposite surfaces of the substrate. Another example is a “multilayer planar cable,” where three or more conductive paths are provided in layers. Such layered paths may be interconnected by means of plated through holes. The layered paths may or may not be continuously provided together throughout the substrate with an exception of such areas occupied by plated through-holes. It is noted that the electrically conductive path(s) in the above examples of this paragraph may be covered by one or more layers of protective coating. Another example is a “rigid-flexible cable” which is a hybrid construction cable including a rigid substrate and a flexible substrate both of which are laminated together into a single structure. Another example is a “polymer film cable,” where the electrically conductive path(s) is printed or deposited onto a polymer substrate.

As used herein, the “flexible planar cable” refers to the aforementioned “planar cable” which also includes at least one electrically conductive path on or over a substrate along its length or width, where its substrate is both planar as well as ‘flexible.’ In this context, throughout this disclosure, the “flexible and planar cable” is to be abbreviated as the “flexible cable” hereinafter, while its “flexible and planar substrate” is to be abbreviated as the “flexible substrate” hereinafter. The “flexible substrate” may be made of and/or include one or more flexible polymeric compounds or, alternatively, may be made of and/or include one or more flexible non-polymeric compounds. Of course, the “flexible substrate” may also be a mixture or a composite of the polymeric and non-polymeric compounds. The “flexible cable” may also include one or more electrically conductive paths on or in the “flexible substrate” in a desired pattern as seen in conventional flexible cables. The electrically conductive path of the “flexible cable” may be incorporated into the flexible substrate, deposited on the flexible substrate, laminated or bonded thereon or otherwise disposed on the flexible substrate using various conventional methods such as, e.g., deposition, lamination, bonding or disposition techniques.

The plastic or polymeric “flexible base (or substrate)” of the “flexible cable” of this disclosure may be made of and/or include various polymeric compounds, where examples of such compounds may include, but not limited to, polyimide, polyester, polyethylene napthalate, polyetherimide, polyether ether ketone, polyethylene terephthalate, various fluoro-polymers, epoxy, aramid, a composite of the above, and the like. The plastic or polymeric “flexible base” may also be made of and/or include other plastic or polymeric substances as long as they exhibit desired flexibility, rigidity, electrical property, temperature tolerance, and so on.

As used herein, the term “signals” refer to those to be transmitted from a signal source to a signal destination at a certain distance. The first category of such “signals” may include, but not limited to, audio signals (i.e., signals carrying audio data), video signals (i.e., signals carrying video data), text signals (i.e., signals carrying text data), and content signals (i.e., all other signals carrying non-audio, non-video, and non-text data), where such signals are to be abbreviated as “data signals” hereinafter. In general, such “data signals” carry a great amount of data and, therefore, require a high data transmission rate such as, e.g., 1 giga bps (bit-per-second), 5 giga bps, 10 giga bps, 20 giga bps, 30 giga bps, 40 giga bps, 50 giga bps, and so on. Accordingly, a bandwidth is one of the important features in transmitting such “data signals.” The second category of such “signals” to be transmitted from the signal source to the signal destination may include “non-data signals” examples of which may include “power signals.” In general, the “non-data signals” may mainly be constant, pulsed or time-varying electrical voltages and/or currents for delivering electrical energy from the signal source to the signal destination. In contrary to the “data signals,” the “non-data signals” generally carry electrical voltage and/or current which may be necessary to turn on equipment associated with the transmission of such “data signals” and, therefore, the “non-data signals” are typically low-frequency signals. Accordingly, the bandwidth is not such an important feature of the “non-data signals.”

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and/or advantages of the present invention will be apparent from the following detailed description, and from the claims.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are schematic cross-sectional views of examples of flexible hybrid cables of the present invention.

FIGS. 2A to 2F are schematic cross-sectional views of examples of other flexible hybrid cables of this invention.

FIGS. 3A to 3F are schematic cross-sectional views of examples of other flexible hybrid cables of this invention, wherein such flexible hybrid cables are similar to those of FIGS. 2A to 2F but also include exemplary electrical insulation coatings.

FIGS. 4A to 4F are schematic cross-sectional views of examples of other flexible hybrid cables of this invention, wherein optical units of such flexible cables generally include clustered optical fibers therein.

FIGS. 5A to 5F are schematic cross-sectional views of examples of other flexible hybrid cables of this invention, wherein optical fibers of optical units are generally interposed between (among) electrical conductive paths of planar cable units.

FIGS. 6A to 6F are schematic cross-sectional views of examples of other flexible hybrid cables of this invention, wherein planar cable units of such flexible cables generally include at least two bases.

FIGS. 7A to 7D are schematic cross-sectional views of examples of other flexible hybrid cables of this invention, wherein such cables generally define elongated cross-sections.

FIGS. 7E and 7F are schematic cross-sectional views of examples of other flexible hybrid cables of this invention, wherein such cables generally define oval or circular cross-sections.

### DETAILED DESCRIPTION OF THE EMBODIMENTS

The present invention relates to various flexible hybrid cables each of which typically includes at least one optical unit and at least one planar cable unit. The exemplary optical unit typically includes at least one conventional optical fiber, and the exemplary planar cable unit typically includes at least one conventional electrically conductive path which is typically provided on at least one surface of a flat or curvilinear base. The present invention also relates to various methods of manufacturing the flexible hybrid cables and to various methods of using such flexible hybrid cables.

One exemplary flexible hybrid cable includes at least one optical unit and at least one planar cable unit, where the optical unit transmits data signals and where the planar cable unit transmits either data or non-data signals. For example, the optical unit is typically designed to carry (relatively, moderately or significantly) high-bandwidth data-signals, whereas the planar cable unit is typically designed to carry (relatively, moderately or significantly) low-bandwidth data signals or non-data signals. Such data signals are those signals which require a high data transmission rate such as, e.g., 0.1 giga bps (bit-per-second), 0.5 giga bps, 1 giga bps, 5 giga bps, 10 giga bps, 20 giga bps, 30 giga bps, 40 giga bps, 50 giga bps, and so on. Therefore, a bandwidth is one of the important features in transmitting such data signals. In contrary, the non-data signals are those signals which require a relatively low data transmission rate such as, e.g., 100 mega bps, 10 mega bps, 1 mega bps or lower. Such non-data signals typically include power signals which may be constant, pulsed or time-varying electrical voltages or currents. Because such non-data signals are typically low-frequency signals, the bandwidth is not such an important feature of the non-data signals. It is to be appreciated throughout this disclosure that the terms “high- or higher-” and “low- or lower-” are relative terms and that the signals of high- or higher-bandwidth may be advantageously transmitted through the optical unit, while the signals of low- or lower-bandwidth may be transmitted through the planar cable unit. When the situation mandates, however, the signals of the high-bandwidth may be transmitted through at least a part of the planar cable unit, and/or the signals of the low-bandwidth may be transmitted through at least a part of the optical unit. In other words, to the extent that such a usage is completely contrary to various objectives of this invention, one of ordinary skill in the relevant art may pick and choose which signals of which bandwidths may be transmitted through the optical unit or planar cable unit of the flexible hybrid cable of this invention.

Another exemplary flexible hybrid cable includes at least one optical unit and at least one planar cable unit, where the optical unit includes at least one conventional flexible optical fiber and where the planar cable unit includes at least one conventional electrically conductive path provided on a flexible base. For example, when a relatively high flexibility is required, the optical unit may include at least one conventional plastic optical fiber and the planar cable unit includes a base which is at least as flexible as the plastic optical fiber. Alternatively, when a relatively lower flexibility is required, the optical unit may include at least one conventional glass optical fiber and the planar cable unit includes a base which is at least as flexible as the glass optical fiber. It is appreciated that such flexibility is a mechanical property of the flexible hybrid cable while bending or deforming at least a portion thereof for handling such a cable, installing such a cable, and so on, where such handling may include, e.g., storing such a cable, connecting such a cable to a suitable connector, and the like. Therefore, it is appreciated throughout this disclosure that, to the extent that such flexibilities do not run completely contrary to various objectives of the present invention, one of ordinary skill in the relevant art may pick and choose the flexibilities of the optical unit and the planar cable unit as he sees fit. In other words, one skilled in the relevant art may select such flexibilities of diverse units as long as an overall flexibility of the flexible hybrid cable of this invention meets the necessary design criteria regarding such flexibility.

Another exemplary flexible hybrid cable includes at least one optical unit and at least one planar cable unit, where the optical includes at least one conventional optical fiber having a circular or oval cross-section, where the planar cable unit includes at least one base having an elongated cross-section, and where at least one conductive path is provided on the base. Accordingly, the flexible hybrid cable in turn defines a cross-section which is also elongated. In other words, such a flexible hybrid cable may be deemed as a relatively flat cable which is surrounded by a relatively flat external cover. Therefore, the relatively flat flexible hybrid cable can be rolled in a specific direction, can prevent twisting or swirling about its length, and so on. Accordingly, it is appreciated throughout this disclosure that one skilled in the relevant art may pick and choose the shapes and/or sizes of the cross-sections of the optical unit and the planar cable unit. In other words, one skilled in the relevant art may vary individual shapes and/or sizes of the optical unit and/or planar cable unit as long as an overall shape and/or size of the flexible hybrid cable of the present invention meets the necessary design criteria regarding such shapes and/or sizes.

Various aspects and embodiments of various flexible hybrid cables and methods of the present invention will now be described more particularly with reference to the accompanying drawings and text, where such aspects and embodiments thereof only represent different forms. However, such cables and methods of this invention may also be embodied in many other different forms and, therefore, should not be limited to such aspects and embodiments which are set forth herein. Rather, various exemplary aspects and embodiments described herein are provided so that this disclosure will be thorough and complete, and fully convey the scope of the present invention to one of ordinary skill in the relevant art.

Unless otherwise specified, it is to be understood that various members, units, elements, and parts of various flexible hybrid cables of the present invention are not typically drawn to scales and/or proportions for ease of illustration. It is also to be understood that such members, units, elements, and parts of various flexible hybrid cables of this invention designated by the same numerals typically represent the same, similar or functionally equivalent members, units, elements, and parts thereof, respectively.

In the first aspect of the present invention, a flexible hybrid cable may include at least one optical unit and at least one planar cable unit, where the optical unit may include at least one optical fiber, while the planar cable unit may include at least one base (or substrate) on, over or in which at least one electrically conductive path is provided.

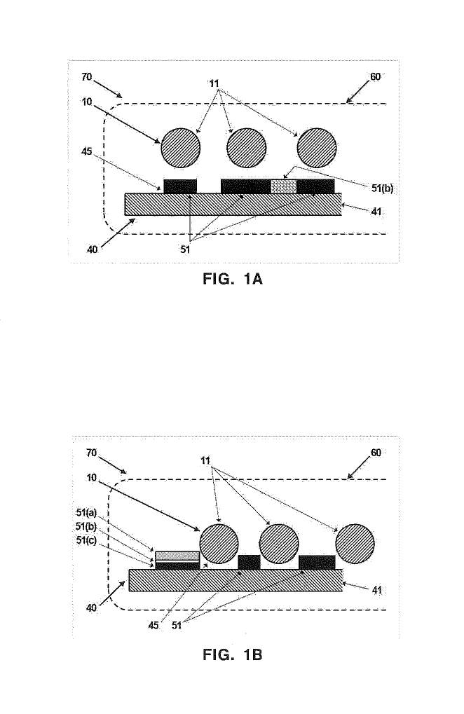

FIG. 1A shows a cross-sectional view of the first exemplary embodiment of this first exemplary aspect of the flexible hybrid cable according to this invention. As shown in the figure, an exemplary flexible hybrid cable 70 includes an optical unit 10, a planar cable unit 40, and an external cover (or jacket) 60.

The optical unit 10 includes three optical fibers 11, where such optical fibers 11 may have the same, similar or different cross-sectional shapes and/or the same, similar or different dimensions or sizes as designated by the hatching, where at least one of such optical fibers may be a prior art plastic optical fiber or, alternatively, where at least one of such optical fibers 11 may be a prior art glass optical fiber, and so on. The optical fibers 11 may also be disposed in various arrangements, where such optical fibers 11 are disposed side by side in the figure.

The planar cable unit 40 includes a base (or substrate) 41 on, over or in which three electrically conductive paths 51 are provided, where FIG. 1A exemplifies a “lateral arrangement” in which multiple conductive paths 51 are formed side by side. The conductive paths 51 may be made of or include identical, similar or different electrically conductive materials such as, e.g., metals, conductive polymers, and other electrically conductive substances, where those 51 of the figure may be made of or include identical materials as denoted by the identical hatchings. The conductive paths 51 may have the same, similar or different heights, the same, similar or different widths, and so on, where such paths 51 in the figure define the same height but have different widths. The conductive paths 51 may be spaced apart from each other, i.e., by defining gaps 45 (or gap spaces) therebetween. When desirable, an electrical insulator 51(b) may be interposed between the adjacent conductive paths 51 in order to ensure electrical insulation therebetween.

The external cover 60 of the figure encloses therein the optical unit 10 as well as the planar cable unit 40. The cover 60 may serve multiple purposes, e.g., protecting the optical and planar cable units 10, 40 from an external environment, preserving physical arrangements between such units 10, 40, and so on. Any cover or jacket of any conventional electrical cables or optical cables can be used for such an external cover 60.

The exemplary flexible hybrid cable 70 may be fabricated using various conventional techniques. For example, a suitable base 41 is selected for the planar cable unit 40, where such a base 41 may be made of a variety of materials. More particularly, the base 41 may be made of or include various polymeric compounds such as, e.g., an electrical insulative compound(s), a mechanically flexible compound(s), and so on, where examples of such polymeric compounds may include, but not limited to, polyimide, polyester, polyethylene napthalate, polyetherimide, polyether ether ketone, polyethylene terephthalate, fluoro-polymers, epoxy, and so on. The plastic or polymeric flexible base 41 may also be made of or include other plastic or polymeric substances as long as they exhibit desired mechanical flexibility, electrical insulation, and so on. Of course the base 41 may be selected from non-polymeric materials as far as such materials exhibit desirable electrical insulation, mechanical flexibility, and so on. Accordingly, the polymeric or non-polymeric base 41 may have a thickness and/or a width which can exhibit the desired mechanical flexibility and electrical insulation, as commonly known to one skilled in the art of plastic science or material science. When desirable, such polymeric and non-polymeric base 41 may also be selected to satisfy other desirable electrical properties (e.g., electric capacitance, etc.), desirable mechanical properties (stiffness, strength, etc.), desirable temperature tolerance (thermal conductivity, heat capacity, melting point, glass transition temperature, etc.), desirable cost, and so on.

Once the suitable base 41 is chosen, a desirable number of electrically conductive paths 51 are then provided thereon or thereover. The conductive paths 51 may be provided on or over the base 41 using many different conventional techniques. In one example, any conventional deposition or disposition techniques followed by etching processes may be used to form such thin and planar conductive paths 51. Other methods for providing electrical circuits or electrical connection in microchips may be also used to provide the thin and planar conductive paths 51. In addition, other conventional technologies for forming thin metal strips such as, e.g., laminating, metalizing, and so on, may also be used to provide such conductive paths 51 on or over the base 41. It is appreciated that such conductive paths 51 may be formed to exhibit certain electrical properties, may be formed in a certain arrangement, may define desirable heights (or thicknesses), widths, and/or lengths, and may be spaced apart from each other while defining gaps 45 therebetween.

When desirable, the conductive paths 51 may be provided at a certain depth into the base 41. In one example, the base 41 may be etched to form a trench (not shown in the figure) of a certain depth and the conductive paths 51 may be formed inside the trench using available conventional techniques. Alternatively, a mask layer or an insulating layer (not shown in the figure) may be deposited over the base 41, portions of the mask or insulating layer may be etched, and then the conductive paths 51 may be formed in the etched portion of the mask or insulating layer. In these examples, such conductive paths 51 may be deemed to be disposed inside the base 41.

Once the planar cable unit 40 is provided, the optical unit 10 is disposed over, laid over, coupled to or otherwise positioned over the planar cable unit 40, and then such units 10, 40 may be placed inside or inserted into the external cover 60. For example, when using a preformed cover 60, conventional jacketing processes may be used in order to dispose the optical unit 10 and planar cable unit 40 inside the cover 60 or in order to cover the optical and planar cable units 10, 40 with the cover 60. Alternatively, the optical unit 10 and planar cable unit 40 may pass through a molten polymer solution so that such units 10, 40 are covered by or insulated inside the polymer when cooled. Other conventional jacketing techniques may also be used to place desired portions of the optical and planar cable units 10, 40 inside the external cover 60. It is appreciated throughout this disclosure that the external cover may be shaped and sized to tightly encompass the optical unit as well as the planar cable unit therein or that the optical and planar cable units loosely fit inside the external cover. Of course, the former arrangement would offer the benefit of maintaining the relative physical arrangement between the optical and planar cable units during manufacturing and use, while the latter arrangement would offer the benefit of allowing such units to rearrange themselves while the flexible hybrid cable is bent during use. Accordingly, one skilled in the relevant art may be able to pick and choose how to cover the optical and planar cable units based on various design criteria.

In operation, a user determines a desired number of electrically conductive paths 51 each having suitable electrical conductivities. The user then determines the width, height, and length of each of the paths 51 so that the resulting planar cable unit 40 can transmit the non-data signals (or data signals, when necessary) at desirable transmission rates. The user also selects a desirable material for the base 41 of the planar cable unit 40 while considering its mechanical flexibility, other electrical or mechanical properties, and so on. The user then disposes the electrically conductive paths 51 on or over the base 41 using the aforementioned techniques, thereby fabricating the planar cable unit 40.

Before or after fabricating the planar cable unit 40, the user determines a desired number of optical fibers 11 each having suitable optical, electrical, and/or mechanical properties. The user disposes the optical fibers 11 in a suitable arrangement, thereby preparing the optical unit 10.

After fabricating the optical and planar cable units 10, 40, the user disposes the optical unit 10 with respect to the planar cable unit 40 in a desirable arrangement, and then inserts them 10, 40 into the external cover 60 or, alternatively, encloses the optical and planar cable units 10, 40 with the cover 60, thereby completing fabrication of the exemplary flexible hybrid cable 70 of the present invention. The user can make such a flexible hybrid cable 70 of a finite length and use it as he sees fit. In the alternative, the user can fabricate the very long flexible hybrid cable 70 and then later cut it into a desirable length for use. Because the base 41 of the planar cable unit 40 is flexible and relatively flat (or planar), the resulting flexible hybrid cable 10 can be relatively easily rolled and stored for later use.

In another operation, a user selects a first number of data signals and a second number of non-data signals both of which are to be transmitted from a signal source to a signal destination or vice versa. The user then selects a flexible hybrid cable 70 which includes an optical unit 10 and a planar cable unit 40 therein, where the optical unit 10 may include therein the first number (or a greater number) of optical fibers 11, where the planar cable unit 40 may include therein the second number (or a greater number) of electrically conductive paths 51, and so on. Of course, the user selects the first number and second number while taking account of the data and non-data signals to be transmitted along the optical and planar cable units 10, 40. In addition and when desirable, the user cuts a suitable length of the flexible hybrid cable from a roll. The user then installs the flexible hybrid cable 70 from the signal source to the signal destination (or vice versa). When desirable, the user can attach a connector to one end or both ends of the flexible hybrid cable 70, where such a connector can receive the optical fibers of the optical unit 10 and/or the electrically conductive paths of the planar cable unit 40. Because the optical fibers 11 of the optical unit 10 are at least minimally flexible and the base 41 of the planar cable unit 40 is also flexible, the user may easily install the flexible hybrid cable 70 between the signal source and destination (or vice versa) while bending, rolling, twisting or otherwise deforming a portion of such cable 70 along a length of the flexible hybrid cable 70. In addition, the flexible hybrid cable 70 includes the planar cable unit 40 which is planar and, therefore, may resist twisting about the length of the cable 70 beyond a certain extent. Accordingly, the user can minimize accidental or undesirable twisting (i.e., axially or about the length) of the cable 70 and resulting damages to the cable 70.

Alternatively, the user may select a flexible hybrid cable 70 which includes an optical unit 10 and a planar cable unit 40 therein, where the optical unit 10 may include therein the first number (or a smaller number) of optical fibers 11, where the planar cable unit 40 may include therein the second number (or a smaller number) of electrically conductive paths 51, and so on. Of course the user may use this alternative arrangement when multiple data or non-data signals may be transmitted through a single optical fiber 11 and the conductive path 51, respectively,

After the flexible hybrid cable 70 is installed between the signal source and destination, the user may transmit the data signals (or when desirable, non-data signals) through the optical fibers 11 of the optical unit 10, while transmitting the non-data signals (or when desirable, data signals) through the conductive paths 51 of the planar cable unit 40. Unlike prior art electrically conductive cables which suffer from electromagnetic interference (to be referred to as “EMI” hereinafter), the flexible hybrid cable 70 needs only minimal insulation to EMI, for the (relatively, moderately or significantly) high-bandwidth data signals are transmitted mostly through the optical fibers 11 of the optical unit 10. Accordingly, the optical unit 10 of the flexible hybrid cable 70 may not generally need any extra insulation against the EMI. In addition, because the data or non-data signals to be transmitted through the conductive paths 51 of the planar cable unit 40 are typically of a lower bit rate, the conductive paths 51 may require only minimal (if at all) insulation against the EMI. Therefore, the user may transmit the same quantity of data signals with an enhanced speed and with less signal distortion due to the reduced EMI. It is appreciated that the planar cable unit 40 of the flexible hybrid cable 70 may not generally need any extra insulation against the EMI. Accordingly, the user may also transmit the same quantity of data signals using a thinner cable 70 as well as at a lower cost.

FIG. 1B shows a cross-sectional view of the second exemplary embodiment of this first exemplary aspect of the flexible hybrid cable according to this invention. As shown in the figure, an exemplary flexible hybrid cable 70 includes an optical unit 10, a planar cable unit 40, and an external cover (or jacket) 60, which are identical or similar to those of FIG. 1A, except the following differences in its structures and/or methods.

The first difference is that the optical fibers 11 of the optical unit 10 of FIG. 1B are disposed substantially proximate to the planar cable unit 40 and, more particularly, substantially proximate to the conductive paths 51 of the planar cable unit 40. The second difference is that at least one of the optical fibers 11 is disposed inside or near the gap 45 formed between the neighboring conductive paths 51. This arrangement offers the benefits of holding the optical fiber 11 in position, maintaining the relative arrangements between the optical unit 10 and the planar cable unit 40, decreasing the thickness of the flexible hybrid cable 70, and so on. The gap 45 may be shaped and sized in order to snug fit the optical fiber 11 therein, may be wider than the diameter of the optical fiber 11 so that the optical fiber 11 can sit therein, may be narrower than the diameter of the optical fiber 11 so that the optical fiber 11 can sit on top of the gap 45 but not therein, and so on. Of course, multiple gaps 45 formed on the base 41 may have the same height, width, and/or length or may rather define different heights, widths and/or lengths. Accordingly, multiple optical fibers 11 may be disposed inside a single gap 45 or supported by a single gap 45. Alternatively, a single optical fiber 11 may be supported by multiple gaps 45, a single optical fiber 11 may sit over multiple gaps 45, and so on.

The third difference is that the planar cable unit 40 of FIG. 1B exemplifies a “vertical (or stacked) arrangement” in which at least two electrically conductive paths 51(a), 51(c) are provided one over the other and at least one insulator 51(b) is provided therebetween to ensure electrical insulation of the vertically arranged conductive paths 51(a), 51(c). Such a vertical arrangement offers the benefit of increasing an electrically conductive area per a unit area of the base 41. Of course such a benefit comes along at the cost of an increasing thickness of the planar cable unit 40 and, possibly with an increasing thickness of the flexible hybrid cable 70.

Other configurational and/or operational characteristics and/or benefits of the flexible hybrid cable of FIG. 1B are similar or identical to those of the flexible hybrid cable of FIG. 1A. Accordingly, various configurational and/or operational characteristics described in conjunction with the flexible hybrid cable of FIG. 1A can also be incorporated into that of FIG. 1B.

It is appreciated that the first and second exemplary embodiments of this first aspect of the flexible hybrid cable of the present invention may include various modifications thereof.

In one modification, the optical unit may include any number of any conventional optical fibers. Accordingly, the optical unit may include only one optical fiber, a pair of optical fibers, an even number of optical fibers (where each two of such fibers may or may not form a pair), an odd number of optical fibers, and so on. When desirable, the optical unit may include less than five optical fibers. Of course the optical unit may include more than five optical fibers. Since most optical fibers are thin, the user can incorporate more than four, six, eight, ten or more optical fibers as he or she sees fit. In addition, the optical fibers may have the same or different chemical compositions, may exhibit the same or different optical properties, may have the same or different shapes and/or sizes, and so on. For example, the optical unit may only include polymer optical fibers, may only include glass optical fibers, may include a combination of polymer and glass optical fibers, and so on.

In another modification and similar to the electrically conductive paths of the planar cable unit, the optical fibers of the optical unit may be disposed in a lateral arrangement, a vertical arrangement or a hybrid arrangement, where the hybrid arrangement refers to the arrangement where at least two optical fibers are disposed in the lateral arrangement, while at least two optical fibers are disposed in the stacked or vertical arrangement.

In another modification, at least two optical fibers may be mechanically coupled to each other by, e.g., being aligned, twisted, braided or otherwise disposed in a desirable mechanical arrangement therebetween. Such mechanical coupling offers the benefit of allowing the user to incorporate into the flexible hybrid cable multiple optical fibers in a desirable arrangement for easier handling of the optical cables (as well as the multiple conductive paths), for connecting such optical fibers (as well as the multiple conductive paths) to an adaptor or connector, and so on. It is appreciated that such optical fibers may couple with each other releasably in such a way that one optical fiber may slide against the other, thereby allowing rather individual bending, twisting or otherwise deforming thereof. Alternatively, such fibers may be mechanically attached to each other or chemically (or thermally) glued or bonded to each other, thereby forcing the optical fibers to bend, twist or otherwise deform together. When desirable, such optical fibers may be coupled to the base, to the conductive paths, to the external cover, and so on.

In another modification, the optical fibers may be coated with an optically inert material along their entire lengths, along predetermined (but not entire) lengths, at preselected locations, and the like. As a result, when the coated optical fibers may contact each other, the optical fibers themselves may not directly contact each other due to such coatings. However, for the simplicity of illustration throughout this disclosure, such optical fibers are deemed to contact each other when their coatings contact each other, when one coated optical fiber contacts another uncoated optical fiber, and the like.

In another modification, the planar cable unit may include thereon, thereover or therein any number of any conventional electrically conductive paths, where such conductive paths may be provided in the lateral arrangement, vertical arrangement or hybrid arrangement. Regardless of the lateral, vertical or hybrid arrangement thereof, the conductive paths may include or may be made of the same or different substances, may exhibit the same or different electrical conductivities, may define the same or different heights, widths, lengths, cross-sectional shapes, and so on. In addition, such conductive paths may be provided in a uniform spacing or in different spacings, thereby forming the same or different gaps therebetween. It is appreciated throughout this disclosure that at least two electrically conductive paths may be electrically connected to each other as the user sees fit. Such an arrangement may allow the user to use the pre-fabricated flexible hybrid cable and adjust the amount of electrical current flowing in such paths, thereby providing the user with a greater freedom in utilizing the planar cable units of the pre-fabricated hybrid cable, e.g., in transmitting different non-data signals of various frequencies, in different bit rates, and the like.

In another modification, the planar cable unit may include any number of any conventional bases or conductive paths. Accordingly, the planar cable unit may include only one base, a pair of bases disposed in the lateral, vertical or hybrid arrangement, an even number of bases (where each two of such bases may or may not form a pair), an odd number of bases, and so on. On each of such bases, one or more electrically conductive paths may be formed on one side or both sides thereof. This design flexibility offers the benefit of allowing the user to fabricate a desirable planar cable unit which defines a desired physical dimension while providing a desired electrically conductive area.

In the second aspect of the present invention, a flexible hybrid cable may include one optical unit and one planar cable unit, where the optical unit may include at least one optical fiber, while the planar cable unit may include at least one base (or substrate) on, over or in which at least one electrically conductive path is provided.

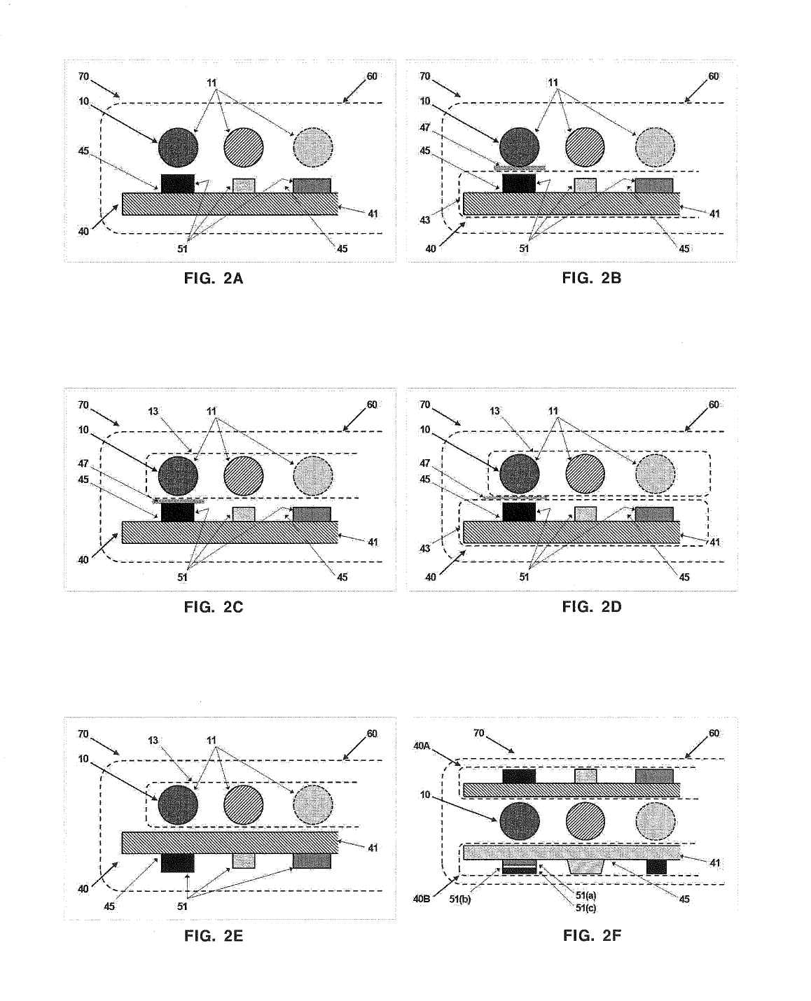

FIG. 2A shows a cross-sectional view of the first exemplary embodiment of this second exemplary aspect of the flexible hybrid cable according to this invention. Similar to that of FIG. 1A, an exemplary flexible hybrid cable 70 of FIG. 2A also includes an optical unit 10, a planar cable unit 40, and an external cover (or jacket) 60. The optical unit 10 includes multiple optical fibers (e.g., three optical fibers in this embodiment) disposed in the lateral arrangement, while the planar cable unit 40 also includes multiple electrically conductive paths 51 (e.g., three conductive paths in this embodiment) disposed in the lateral arrangement.

Although the number of optical fibers of the optical unit is identical to the number of the electrically conductive paths of the planar cable unit in this embodiment, the optical unit may include more or fewer optical fibers than the conductive paths in the planar cable unit. In addition and as shown in the figure, at least one optical fiber and at least one conductive path may be disposed to abut each other, at least one optical fiber and at least one gap formed between such conductive paths may be disposed to abut each other, and the like.

Other configurational and/or operational characteristics and/or benefits of the flexible hybrid cable of FIG. 2A are similar or identical to those of the flexible hybrid cables of FIGS. 1A and 1B. Accordingly, various configurational and/or operational characteristics and/or benefits described in conjunction with the flexible hybrid cables of FIGS. 1A and 1B can also be incorporated into that of FIG. 2A. Conversely, various configurational and/or operational characteristics and/or benefits described in conjunction with the flexible hybrid cable of FIG. 2A can be incorporated to the flexible hybrid cables of FIGS. 1A to 1B.

FIG. 2B shows a cross-sectional view of the second exemplary embodiment of this second exemplary aspect of the flexible hybrid cable according to this invention. Similar to that of FIG. 2A, an exemplary flexible hybrid cable 70 of FIG. 2B also includes an optical unit 10, a planar cable unit 40, and an external cover (or jacket) 60. However, the flexible hybrid cable 70 of FIG. 2B differs from that of FIG. 2A, in that a second cover 43 encloses at least a portion of the planar cable unit 40, thereby providing mechanical protection to the planar cable unit 40, providing electrical insulation thereto, facilitating easier positioning of the planar cable unit 40 inside the external cover 60, and so on. It is appreciated that the second cover 43 may include or may be made of materials as commonly used to fabricate the external cover 60 or other conventional jackets. It is appreciated that the second cover 43 serves as an inner cover and, therefore, that the second cover 43 may be thinner than an external cover (or jacket) of other conventional electric or optical cables. Of course the user may employ the second cover 43 which is thicker than the external cover 60.

Although not shown in the figure, the second cover 43 may enclose therein at least a portion of the optical unit 10, at least one optical fiber 11, and the like. Alternatively, the second cover 43 may define at least one opening through which the second cover 43 may cover at least a portion of the optical unit 10, at least one optical fiber 11, and the like. Alternatively, at least one optical fiber 11 may sit on top of the second cover 43, thereby providing easier maintenance of the position of such an optical fiber 11 or the optical unit 10 with respect to the planar cable unit 40.

Another characteristic of the exemplary flexible hybrid cable 70 of FIG. 2B relates to a coupling unit 47 which is disposed between at least a portion of the optical unit 10 and at least a portion of the planar cable unit 40. The main function of the coupling unit 47 is to mechanically or chemically abut, support, couple or bond at least a portion of the optical unit 10 to at least a portion of the planar cable unit 40, thereby maintaining the relative positions of such units 10, 40 during handling and installing of the flexible hybrid cable 70. Therefore, the coupling unit 47 may include a conventional mechanical holder for releasably or fixedly grabbing at least a portion of the optical fiber(s) 11, another conventional mechanical holder for releasably or fixedly retaining at least a portion of the optical fiber(s) 11 therein, a groove(s) in which the optical fiber(s) 11 can releasably or fixedly sit, and so on. The coupling unit 47 may instead include conventional adhesive to attach at least a portion of the optical fiber(s) 11 to at least a portion of the planar cable unit 40. It is appreciated that any other conventional mechanical and/or chemical couplers may be employed as long as such can maintain relative positions of the optical fiber(s) 11 with respect to the second cover 43.

When desirable, the coupling unit 47 may be disposed in different positions inside the flexible hybrid cable 70. For example, the coupling unit may be disposed between the planar cable unit 40 and an inner surface of the second cover. In another example, the coupling unit can be disposed between the planar cable unit 40 and an inner bottom surface of the external cover 60 (or an inner side surface thereof). Alternatively, the flexible hybrid cable 70 can include multiple coupling units each of which may be disposed in any desirable position to releasably or fixedly couple the optical unit to the external cover, couple the optical unit to the planar cable unit, couple the planar cable unit to the external cover, and the like.

Other configurational and/or operational characteristics and/or benefits of the flexible hybrid cable of FIG. 2B are similar or identical to those of the flexible hybrid cables of FIGS. 1A and 1B and FIG. 2A. Accordingly, various configurational and/or operational characteristics and/or benefits described in conjunction with the flexible hybrid cables of FIGS. 1A and 1B and FIG. 2A can also be incorporated into that of FIG. 2B. Conversely, various configurational and/or operational characteristics and/or benefits described in conjunction with the flexible hybrid cable of FIG. 2B can be incorporated to the flexible hybrid cables of FIGS. 1A to 1B and FIG. 2A.

FIG. 2C shows a cross-sectional view of the third exemplary embodiment of this second exemplary aspect of the flexible hybrid cable according to this invention. Similar to that of FIG. 2A, an exemplary flexible hybrid cable 70 of FIG. 2C also includes an optical unit 10, a planar cable unit 40, and an external cover (or jacket) 60. However, the flexible hybrid cable 70 of FIG. 2C differs from that of FIG. 2A, in that a first cover 13 encloses at least a portion of the optical unit 10, thereby providing mechanical protection to the optical unit 10, providing optical insulation thereto, facilitating easier positioning of the optical unit 10 inside the external cover 60, and so on. It is appreciated that the first cover 43 may include or may be made of materials as commonly used to fabricate an external cover (or jacket) of other conventional optical or electric cables. It is appreciated that the first cover 13 is an inner cover and, therefore, that the first cover 13 may be thinner than the external cover (or jacket) of other conventional optical or electric cables. Of course the user may employ the first cover 13 which is thicker than the external cover of other prior art optical or electric cables. Another characteristic of the exemplary flexible hybrid cable 70 of FIG. 2C relates to another coupling unit 47 which is disposed between the optical unit 10 and the planar cable unit 40 and which is similar or identical to that of FIG. 2B.

Although not shown in the figure, the first cover 13 may enclose therein at least a portion of the planar cable unit 40, at least one electrically conductive path 51, and the like. Alternatively, the first cover 13 may define at least one opening through which the first cover 13 may cover at least a portion of the planar cable unit 40, at least one conductive path 51, and the like. Alternatively, at least one conductive path 51 may be positioned below the first cover 13, thereby providing easier maintenance of the position of the planar cable unit 40 with respect to the optical unit 10.

Other configurational and/or operational characteristics and/or benefits of the flexible hybrid cable of FIG. 2C are similar or identical to those of the flexible hybrid cables of FIGS. 1A and 1B and FIGS. 2A and 2B. Accordingly, various configurational and/or operational characteristics and/or benefits described in conjunction with the flexible hybrid cables of FIGS. 1A and 1B and FIGS. 2A and 2B can also be incorporated into that of FIG. 2C. Conversely, various configurational and/or operational characteristics and/or benefits described in conjunction with the flexible hybrid cable of FIG. 2C can be incorporated to the flexible hybrid cables of FIGS. 1A to 1B and FIGS. 2A and 2B.

FIG. 2D is a cross-sectional view of the fourth exemplary embodiment of this second exemplary aspect of the flexible hybrid cable according to this invention. Similar to that of FIG. 2A, an exemplary flexible hybrid cable 70 of FIG. 2D includes an optical unit 10, a planar cable unit 40, and an external cover (or jacket) 60. The exemplary flexible hybrid cable 70 of FIG. 2D also includes the second cover 43 of FIG. 2B as well as the first cover 13 of FIG. 2C, thereby providing mechanical protection to the optical and planar cable units 10, 40, providing optical and electrical insulation to such units 10, 40, respectively, facilitating easier positioning of such units 10, 40 inside the external cover 60, and so on. Accordingly, the flexible hybrid cable 70 of FIG. 2D may also include one or more coupling units 47 of FIG. 2C in various positions inside the external cover 60 as described in conjunction with FIGS. 2B and 2C, to mechanically or chemically abut, support, couple or bond at least a portion of the first cover 13 to at least a portion of the second cover 43, and the like.

Other configurational and/or operational characteristics and/or benefits of the flexible hybrid cable of FIG. 2D are similar or identical to those of the flexible hybrid cables of FIGS. 1A and 1B and FIGS. 2A to 2C. Accordingly, various configurational and/or operational characteristics and/or benefits described in conjunction with the flexible hybrid cables of FIGS. 1A and 1B and FIGS. 2A to 2C can also be incorporated into that of FIG. 2D. Conversely, various configurational and/or operational characteristics and/or benefits described in conjunction with the flexible hybrid cable of FIG. 2D can be incorporated to the flexible hybrid cables of FIGS. 1A to 1B and FIGS. 2A to 2C.

FIG. 2E shows a cross-sectional view of the fifth exemplary embodiment of this second exemplary aspect of the flexible hybrid cable according to this invention. Similar to that of FIGS. 2A to 2D, an exemplary flexible hybrid cable 70 of FIG. 2E also includes an optical unit 10, a planar cable unit 40, and an external cover (or jacket) 60. However, the planar cable unit 40 includes multiple electrically conductive paths 51 provided on a bottom surface of the base 41, i.e., the surface of the planar cable unit 40 not facing the optical unit 10. Accordingly, the optical unit 10 may sit proximate to or on a relatively flat top surface of the base 41 on which no conductive paths are provided. Although not shown in the figure, at least one sitting portion such as, e.g., a groove or a protrusion, may be formed on the top surface in which at least one optical fiber 11 may sit. This arrangement enables the user to easily position the optical fiber 11 with respect to the planar cable unit 40, may protect the optical fiber 11 from mechanical impact, and so on.

When desirable, the planar cable unit 40 may be provided with one or more conductive path 51 on the bottom surface as well as one or more conductive path on the top surface. This arrangement offers the benefit of maximizing an electrically conductive area per a unit area of the base 41, more easily disposing different conductive paths on different sides of the base 41, forming desirable gaps 45 on different sides of the base 41, and so on.

Other configurational and/or operational characteristics and/or benefits of the flexible hybrid cable of FIG. 2E are similar or identical to those of the flexible hybrid cables of FIGS. 1A and 1B and FIGS. 2A to 2D. Accordingly, various configurational and/or operational characteristics and/or benefits described in conjunction with the flexible hybrid cables of FIGS. 1A and 1B and FIGS. 2A to 2D can also be incorporated into that of FIG. 2E. Conversely, various configurational and/or operational characteristics and/or benefits described in conjunction with the flexible hybrid cable of FIG. 2E can be incorporated to the flexible hybrid cables of FIGS. 1A to 1B and FIGS. 2A to 2D.

In the sixth exemplary embodiment of this second exemplary aspect of the invention, the flexible hybrid cable may include more than one optical unit and/or more than one planar cable unit each of which has been disclosed in FIGS. 1A and 1B or FIGS. 2A to 2E. Accordingly, the flexible hybrid cable may include one optical unit and multiple planar cable units, multiple optical units and one planar cable units, or multiple optical units and multiple planar cable units. In addition, such multiple optical units and/or planar cable units may be arranged in the lateral, vertical or hybrid arrangement in which some optical and/or planar cable units are disposed side by side, while other optical and/or planar cable units are disposed in the vertical arrangement. In addition, a single optical unit or at least one of multiple optical units may be disposed on top (or bottom) of a single or multiple planar cable units, a single optical unit or at least one of multiple optical units may be sandwiched between multiple planar cable units, and so on. When the flexible hybrid cable includes multiple optical units or planar cable units, such units may be identical or may be different from each other.

FIG. 2F is one example of this sixth exemplary embodiment of this second aspect of the flexible hybrid cable of the invention, where the flexible hybrid cable 70 includes a single optical unit 10 and a pair of planar cable units 40A, 40B and where the optical unit 10 is sandwiched between the upper planar cable unit 40A and the lower planar cable unit 40B. As shown in the figure, the upper planar cable unit 40A is identical to that of FIG. 2D, while the lower planar cable unit 40B is identical to the combination of FIGS. 1B and 2E. When desirable, other planar cable units exemplified in FIG. 1A and FIGS. 2A to 2D may be used as the upper planar cable unit 40A or lower planar cable unit 40B of FIG. 2F.

Other configurational and/or operational characteristics and/or benefits of the flexible hybrid cable of FIG. 2F are similar or identical to those of the flexible hybrid cables of FIGS. 1A and 1B and FIGS. 2A to 2E. Accordingly, various configurational and/or operational characteristics and/or benefits described in conjunction with the flexible hybrid cables of FIGS. 1A and 1B and FIGS. 2A to 2E can also be incorporated into that of FIG. 2F. Conversely, various configurational and/or operational characteristics and/or benefits described in conjunction with the flexible hybrid cable of FIG. 2F can be incorporated to the flexible hybrid cables of FIGS. 1A to 1B and FIGS. 2A to 2E.

In the third aspect of the present invention, a flexible hybrid cable may include one optical unit and one planar cable unit, where the optical unit may include at least one optical fiber, where the planar cable unit may include at least one base (or substrate) on, over or in which at least one electrically conductive path is provided, and where at least a portion of at least one surface of the planar cable unit is covered with at least one layer of coating which serves for various purposes such as, e.g., mechanical protection, mechanical support or arrangement, electrical insulation, shielding against the EMI, and the like.

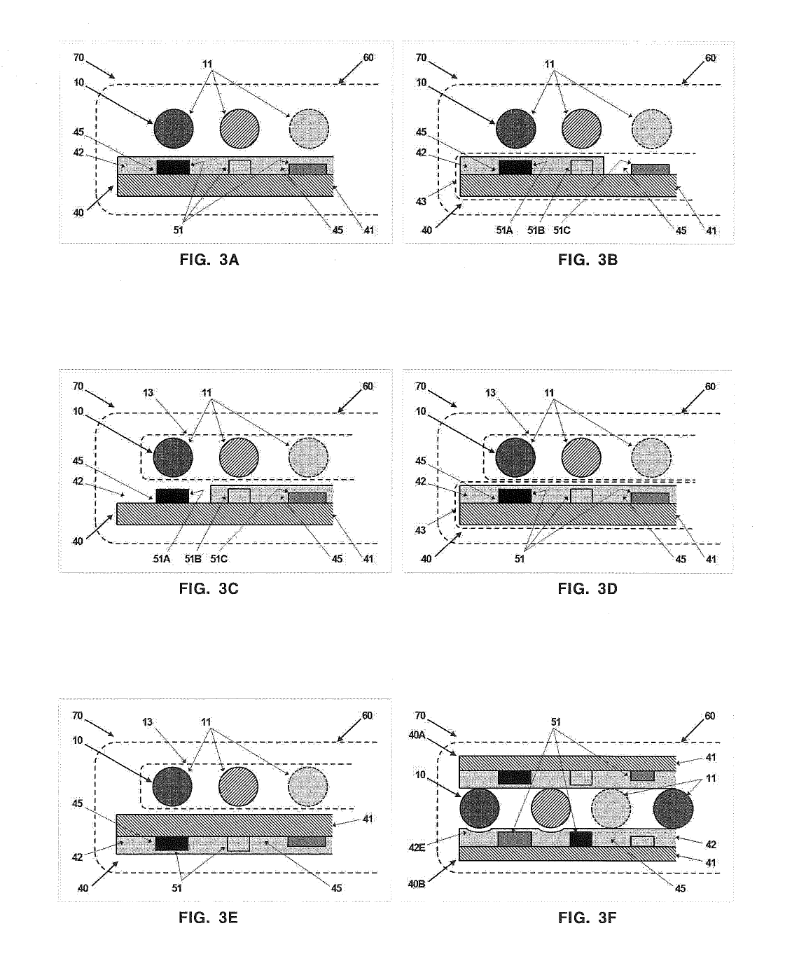

FIG. 3A shows a cross-sectional view of the first exemplary embodiment of this third exemplary aspect of the flexible hybrid cable according to this invention. Similar to that of FIG. 2A, an exemplary flexible hybrid cable 70 of FIG. 3A includes an optical unit 10, a planar cable unit 40, and an external cover (or jacket) 60, where the optical unit 10 includes multiple optical fibers (e.g., three optical fibers in this embodiment) disposed in the lateral arrangement, while the planar cable unit 40 includes multiple electrically conductive paths 51 (e.g., three conductive paths in this embodiment) disposed in the lateral arrangement. In addition, at least a portion of the planar cable unit 40 may be covered with a layer of coating, where the coating 42 of FIG. 3A covers the top surface of the base 41 of the planar cable unit 40 in a uniform height.

The coating 42 may serve various functions. For example, the coating 42 may include or be made of electrically insulative material so as to provide electrical insulation to the electrically conductive paths 51 provided on the base 41 of the planar cable unit 40. The coating 42 may include or be made of metals or other electrically conductive material to shield the conductive paths 51 from EMI. The coating 42 may also include or be made of mechanically flexible material so as to provide mechanical protection to the conductive paths 51 while ensuring the maximal or minimal flexibility of the planar cable unit 40. The coating 42 may also include or be made of material which forms a sticky surface and releasably or fixedly stick to the optical unit 10 and positions the optical unit 10 in the desirable location inside the external cover 60.

The coating 42 may be deposited on top of the base 41 in a uniform height so that the top surface of the planar cable unit 40 defines a flat surface. In the alternative, the coating 42 may have a non-uniform height which varies across the base 41. When desirable, the coating 42 may be covered in specific areas of the base 41, e.g., preferentially on top of the conductive paths 51, preferentially in the gaps 45, and so on. In addition, the planar cable unit 40 may be provided with the coating 42 not only on its top surface but also on its bottom surface. When desirable, the coatings 42 provided on the top and bottom surface of the planar cable unit 40 may be identical. Alternatively, different coatings 42 may be provided on the top and bottom surfaces of the planar cable unit 40. In addition, the coating 42 may be provided on or below the base 41 and then one or more conductive paths 51 may be provided thereon or therebelow.

Although not shown in the figure, the coating 42 may be provided in a height less than the height of the conductive path 51 so that at least a portion of such a path 51 may be exposed. This coating 42 may be desirable when the primary role of the coating 42 is to provide electrical insulation between the adjacent sides of the neighboring paths 51, when the mechanical impact onto the top surface of the planar cable unit 40 is less likely, and the like. In addition, the coating 42 may be composed of multiple layers of different substances at least two of which have different mechanical or electrical properties.

Other configurational and/or operational characteristics and/or benefits of the flexible hybrid cable of FIG. 3A are similar or identical to those of the flexible hybrid cables of FIGS. 1A to 1B and FIGS. 2A to 2F. Accordingly, various configurational and/or operational characteristics and/or benefits described in conjunction with the flexible hybrid cables of FIGS. 1A to 1B and FIGS. 2A to 2F can also be incorporated into that of FIG. 3A. Conversely, various configurational and/or operational characteristics and/or benefits described in conjunction with the flexible hybrid cable of FIG. 3A can be incorporated to the flexible hybrid cables of FIGS. 1A to 1B and FIGS. 2A to 2F.

FIG. 3B shows a cross-sectional view of the second exemplary embodiment of this third exemplary aspect of the flexible hybrid cable according to this invention. Similar to that of FIG. 3A, an exemplary flexible hybrid cable 70 of FIG. 3B includes an optical unit 10, a planar cable unit 40, and an external cover (or jacket) 60. In addition, the flexible hybrid cable 70 of FIG. 3B further includes a second cover 43 as explained in FIGS. 2B, 2D, and 2F. It is noted, however, that the coating 42 of this exemplary embodiment may only cover a portion of the planar cable unit 40 (e.g., only the first and second conductive paths 51A, 51B but not the third one 51C).

FIG. 3C shows a cross-sectional view of the third exemplary embodiment of this third exemplary aspect of the flexible hybrid cable according to this invention. Similar to that of FIG. 3A, an exemplary flexible hybrid cable 70 of FIG. 3B includes an optical unit 10, a planar cable unit 40, and an external cover (or jacket) 60. In addition, the flexible hybrid cable 70 of FIG. 3B further includes a first cover 13 as explained in FIGS. 2C, 2D, and 2E. It is noted, however, that the coating 42 of this exemplary embodiment may only cover a portion of the planar cable unit 40 (e.g., only the second and third conductive paths 51B, 51C but not the first one 51A).

FIG. 3D shows a cross-sectional view of the fourth exemplary embodiment of this third exemplary aspect of the flexible hybrid cable according to this invention. Similar to that of FIG. 3A, an exemplary flexible hybrid cable 70 of FIG. 3B includes an optical unit 10, a planar cable unit 40, and an external cover (or jacket) 60. In addition, the flexible hybrid cable 70 of FIG. 3B further includes a first cover 13 as explained in FIGS. 2C, 2D, 2E, and 3C as well as the second cover 43 as explained in FIGS. 2B, 2D, 2F, and 3B.

Other configurational and/or operational characteristics and/or benefits of the flexible hybrid cables of FIGS. 3B to 3D are similar or identical to those of the flexible hybrid cables of FIGS. 1A to 1B, FIGS. 2A to 2F, and FIG. 3A. Accordingly, various configurational and/or operational characteristics and/or benefits described in conjunction with the flexible hybrid cables of FIGS. 1A to 1B, FIGS. 2A to 2F, and FIG. 3A can also be incorporated into any of those of FIGS. 3B to 3D. Conversely, various configurational and/or operational characteristics and/or benefits described in conjunction with the flexible hybrid cables of FIGS. 3B to 3D can be incorporated to the flexible hybrid cables of FIGS. 1A to 1B, FIGS. 2A to 2F, and FIG. 3A.

FIG. 3E shows a cross-sectional view of the fifth exemplary embodiment of this third exemplary aspect of the flexible hybrid cable according to this invention. Similar to that of FIG. 3A, an exemplary flexible hybrid cable 70 of FIG. 3B includes an optical unit 10, a planar cable unit 40, and an external cover (or jacket) 60. However, similar to that of FIG. 2E, the planar cable unit 40 includes one or more conductive paths 51 provided on the bottom surface of the base 41 and the coating 42 also provided on that bottom surface in order to cover at least a portion of base 41 and at least one conductive path 51.

Other configurational and/or operational characteristics and/or benefits of the flexible hybrid cable of FIG. 3E are similar or identical to those of the flexible hybrid cables of FIGS. 1A to 1B, FIGS. 2A to 2F, and FIGS. 3A to 3D. Accordingly, various configurational and/or operational characteristics and/or benefits described in conjunction with the flexible hybrid cables of FIGS. 1A to 1B, FIGS. 2A to 2F, and FIGS. 3A to 3D can also be incorporated into that of FIG. 3E. Conversely, various configurational and/or operational characteristics and/or benefits described in conjunction with the flexible hybrid cable of FIG. 3E can be incorporated to the flexible hybrid cables of FIGS. 1A to 1B, FIGS. 2A to 2F, and FIGS. 3A to 3D.

FIG. 3F the sixth exemplary embodiment of this third aspect of the invention, where the flexible hybrid cable 70 includes a single optical unit 10 and a pair of planar cable units 40A, 40B and where the optical unit 10 is sandwiched between the upper planar cable unit 40A and the lower planar cable unit 40B. Accordingly, this flexible hybrid cable 70 is similar to that of FIG. 2F, except that both of the upper and lower cable units 40A, 40B include the coatings 42 on the surfaces facing the optical unit 10. It is appreciated, as shown in the figure, that at least one planar cable unit 40B includes at least one sitting portion 42E which is shaped and sized to receive at least a portion of the optical fiber 11 in order to facilitate position of the fiber 11 at a designated position inside the external cover 60.

It is appreciated that a single or multiple coatings 42 may be provided to various planar cable units 40. For example and as shown in the figure, the coatings 42 may be provided to the bottom surface of the upper planar cable unit 40A and the top surface of the upper planar cable unit 40B. When desirable, the coating 42 may be provided on other surfaces of the planar cable units 40A, 40B or both of the top and bottom surfaces of the upper and/or lower planar cable units 40A, 40B.

Other configurational and/or operational characteristics and/or benefits of the flexible hybrid cable of FIG. 3F are similar or identical to those of the flexible hybrid cables of FIGS. 1A to 1B, FIGS. 2A to 2F, and FIGS. 3A to 3E. Accordingly, various configurational and/or operational characteristics and/or benefits described in conjunction with the flexible hybrid cables of FIGS. 1A to 1B, FIGS. 2A to 2F, and FIGS. 3A to 3E can also be incorporated into that of FIG. 3F. Conversely, various configurational and/or operational characteristics and/or benefits described in conjunction with the flexible hybrid cable of FIG. 3F can be incorporated to the flexible hybrid cables of FIGS. 1A to 1B, FIGS. 2A to 2F, and FIGS. 3A to 3E.

In the fourth aspect of the present invention, a flexible hybrid cable may include one optical unit and one planar cable unit, where the optical unit may include multiple optical fibers which are clustered into at least one bundle, where the bundle may include at least two optical fibers therein. Of course the bundle may include the same optical fibers or different optical fibers, where the different optical fibers may differ in the materials they are made of, may differ in their shapes or sizes, and the like. In addition, at least two optical fibers of the bundle may be disposed close to each other such that they may contact or touch each other. Alternatively, at least two optical fibers of the bundle may be disposed at a certain distance from each other.

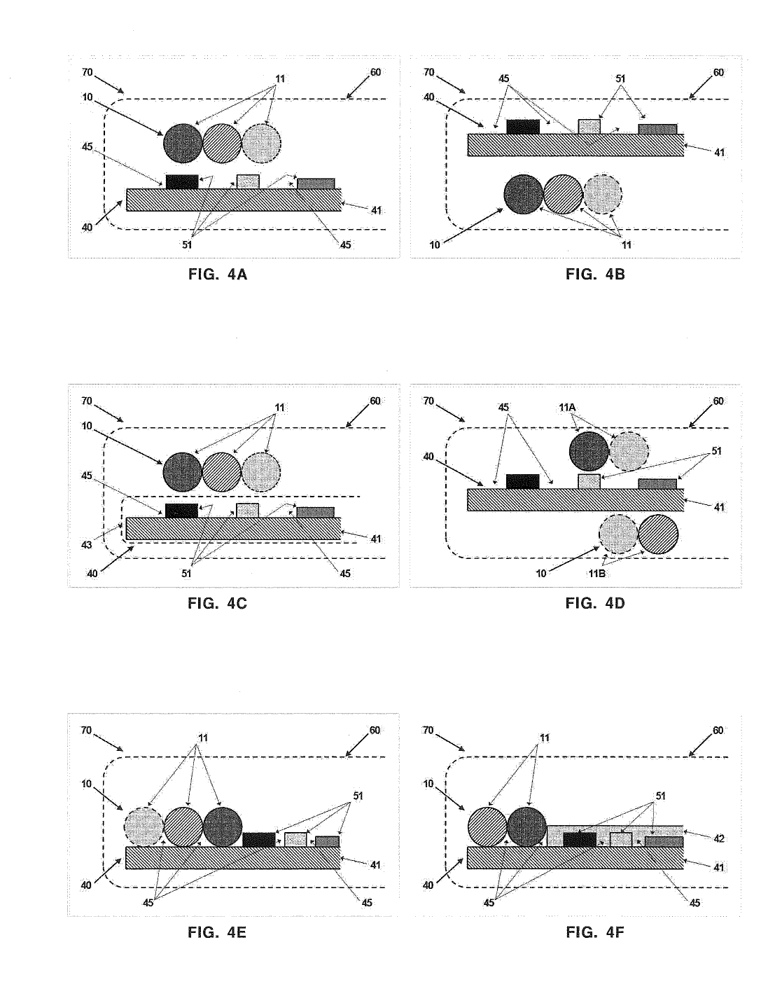

FIG. 4A shows a cross-sectional view of the first exemplary embodiment of this fourth exemplary aspect of the flexible hybrid cable according to this invention. The exemplary flexible hybrid cable 70 includes an optical unit 10, a planar cable unit 40, and an external cover (or jacket) 60, where the optical unit 10 includes multiple optical fibers 11 (e.g., three optical fibers in this embodiment) which are disposed in the lateral arrangement and also clustered into a bundle, where such optical fibers 11 may directly contact each other, may be spaced apart from each other, and the like. In this embodiment, the bundle of the optical fibers 11 is generally disposed over the upper surface of the planar cable unit 40. Alternatively, the optical unit 10 (i.e., the bundle of the optical fibers 11) may be disposed right on top of the upper surface of the base 41 of the planar cable unit 40.

Although not shown in the figure, at least one of the optical fibers 11 of the bundle may be stacked on top of another fiber or fibers 11. In other words, the user can form the bundle of optical fibers by spreading such fibers 11 or by stacking such fibers 11. In the alternative, the optical fibers 11 may be spread one after another to form a file and then the file of fibers may be spread flat or wound on top of the planar cable unit 40.

FIG. 4B shows a cross-sectional view of the second exemplary embodiment of this fourth exemplary aspect of the flexible hybrid cable according to this invention. The exemplary flexible hybrid cable 70 is similar to that of FIG. 4A, except that the optical unit 10 (i.e., the bundle of the optical fibers 11) is disposed under the lower surface of the planar cable unit 40. When desirable, the optical unit 10 may be disposed right under the lower surface of the base 41 of the planar base unit 40.

FIG. 4C shows a cross-sectional view of the third exemplary embodiment of this fourth exemplary aspect of the flexible hybrid cable according to this invention. The exemplary flexible hybrid cable 70 is similar to that of FIG. 4A, except that at least a portion of the planar cable unit 40 is disposed inside at least one second cover 43 which is similar to those of FIGS. 2B, 2D, and 2F and which encloses therein at least a portion of the planar cable unit 40. When desirable, the flexible hybrid cable 70 may also include at least one first cover (not shown in the figure) which is similar to those of FIGS. 2C, 2D, and 2E and which encloses therein at least a portion of the optical unit 10.

Other configurational and/or operational characteristics and/or benefits of the flexible hybrid cables of FIGS. 4A to 4C are similar or identical to those of the flexible hybrid cables of FIGS. 1A to 1B, FIGS. 2A to 2F, and FIGS. 3A to 3F. Accordingly, various configurational and/or operational characteristics and/or benefits described in conjunction with the flexible hybrid cables of FIGS. 1A to 1B, FIGS. 2A to 2F, and FIGS. 3A to 3F can also be incorporated into that of at least one of FIGS. 4A to 4C. Conversely, various configurational and/or operational characteristics and/or benefits described in conjunction with the flexible hybrid cables of FIGS. 4A to 4C can be incorporated to the flexible hybrid cables of FIGS. 1A to 1B, FIGS. 2A to 2F, and FIGS. 3A to 3F.

FIG. 4D shows a cross-sectional view of the fourth exemplary embodiment of this fourth exemplary aspect of the flexible hybrid cable according to this invention. The exemplary flexible hybrid cable 70 is similar to that of FIG. 4A, except that the optical unit 10 includes two bundles of the optical fibers 11A, 11B, where the optical fibers 11A of the upper bundle are disposed on top of the planar cable unit 40, while the optical fibers 11B of the lower bundle are disposed below the planar cable unit 40. The bundles may include, as shown in the figure, the same number of the optical fibers or, in the alternative, different number of the optical fibers. In addition, the optical fibers in one bundle may be all glass optical fibers, all plastic fibers or a combination thereof. Furthermore, the optical fibers of one bundle may define the same length, diameter, cross-sectional shape, and/or cross-sectional area or, in the alternative, different lengths, diameters, cross-sectional shapes, and/or cross-sectional areas.

Other configurational and/or operational characteristics and/or benefits of the flexible hybrid cable of FIG. 4D are similar or identical to those of the flexible hybrid cables of FIGS. 1A to 1B, FIGS. 2A to 2F, FIGS. 3A to 3F, and FIGS. 4A to 4C. Accordingly, various configurational and/or operational characteristics and/or benefits described in conjunction with the flexible hybrid cables of FIGS. 1A to 1B, FIGS. 2A to 2F, FIGS. 3A to 3F, and FIGS. 4A to 4C can also be incorporated into that of at least one of FIG. 4D. Conversely, various configurational and/or operational characteristics and/or benefits described in conjunction with the flexible hybrid cable of FIG. 4D can be incorporated to the flexible hybrid cables of FIGS. 1A to 1B, FIGS. 2A to 2F, FIGS. 3A to 3F, and FIGS. 4A to 4C.

FIG. 4E shows a cross-sectional view of the fifth exemplary embodiment of this fourth exemplary aspect of the flexible hybrid cable according to this invention. The exemplary flexible hybrid cable 70 is similar to that of FIG. 4A, except that the optical unit 10 includes at least one bundle of the optical fibers 11, where the optical fibers 11 of at least one bundle are disposed on top of the base 41, whether directly on top of the top (or bottom) surface of the base 41 or at a certain distance from such a surface of the base 41. As shown in the figure, such optical fibers 11 of one bundle may be disposed in the gap 45 which is formed between one conductive path 51 and one end of the base 41. Alternatively, such optical fibers of the bundle may be disposed in the gap formed between two adjacent conductive paths 51.

FIG. 4F shows a cross-sectional view of the sixth exemplary embodiment of this fourth exemplary aspect of the flexible hybrid cable according to this invention. The exemplary flexible hybrid cable 70 is similar to that of FIG. 4E, except that the optical fibers 11 of at least one bundle are disposed on top of the base 41 and adjacent to or abutting the coating 42 which covers or encloses therein at least one conductive path 51.

Other configurational and/or operational characteristics and/or benefits of the flexible hybrid cables of FIGS. 4E and 4F are similar or identical to those of the flexible hybrid cables of FIGS. 1A to 1B, FIGS. 2A to 2F, FIGS. 3A to 3F, and FIGS. 4A to 4D. Accordingly, various configurational and/or operational characteristics and/or benefits described in conjunction with the flexible hybrid cables of FIGS. 1A to 1B, FIGS. 2A to 2F, FIGS. 3A to 3F, and FIGS. 4A to 4D can also be incorporated into that of at least one of FIGS. 4E and 4F. Conversely, various configurational and/or operational characteristics and/or benefits described in conjunction with the flexible hybrid cables of FIGS. 4E and 4F can be incorporated to the flexible hybrid cables of FIGS. 1A to 1B, FIGS. 2A to 2F, FIGS. 3A to 3F, and FIGS. 4A to 4D.

It is noted that the bundles of optical fibers of the optical unit of the flexible hybrid cables of this fourth aspect of the invention (as exemplified in FIGS. 4A to 4F) offer the benefit of easier handling and/or positioning of the optical fibers. Therefore, the user may position all or at least a substantial number of the optical fibers on one side of the flexible hybrid cable, while positioning the conductive paths on another side (e.g., an opposite side on the same side of the base or a different side of the base) of the flexible hybrid cable. In addition, because the optical fibers are clustered in the bundle, such a flexible hybrid cable requires, if any, a minimum amount of the first covers for mechanical protection, EMI shielding, and the like.

In the fifth aspect of the present invention, a flexible hybrid cable may include one optical unit and one planar cable unit, where the optical unit includes multiple optical fibers, where the planar cable unit includes multiple electrically conductive paths while defining gaps therebetween, and where the optical fibers of the optical unit may be disposed in or on the gap or, in other words, such fibers may be interposed between the conductive paths. Such arrangements of the optical unit are similar to the aforementioned lateral arrangements, except that the optical fibers of the optical unit may be disposed more proximate to the conductive paths of the planar cable unit or may physically contact, touch or abut the conductive paths and/or the base.

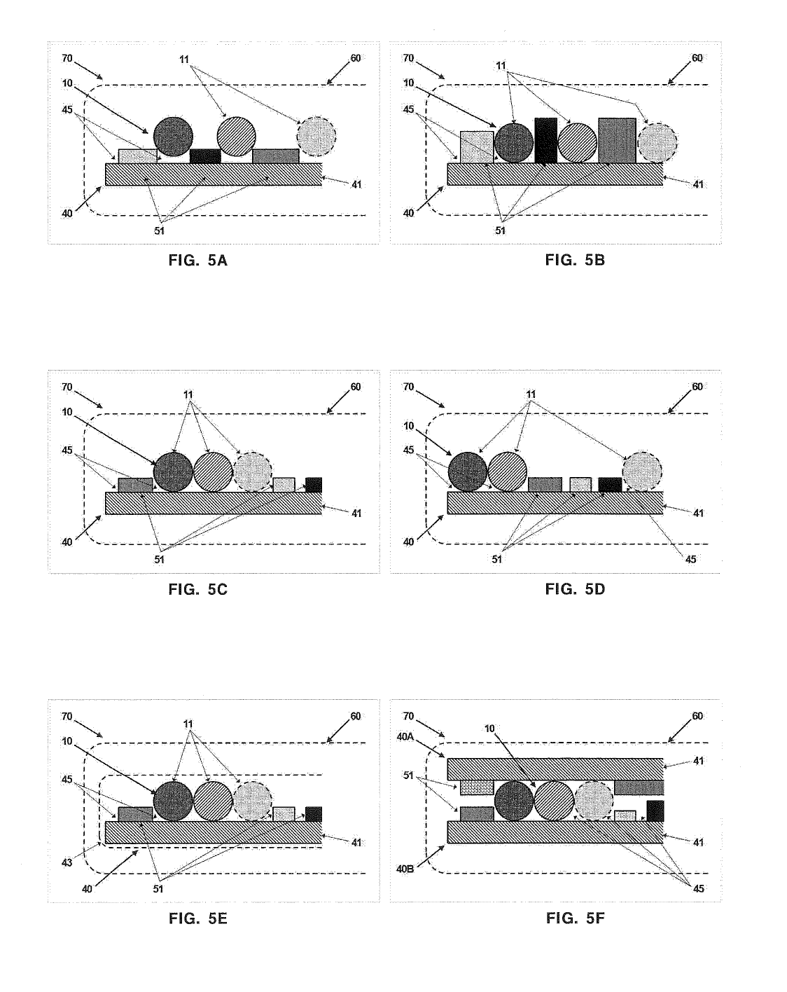

FIG. 5A shows a cross-sectional view of the first exemplary embodiment of this fifth exemplary aspect of the flexible hybrid cable according to this invention. As shown in the figure, an exemplary flexible hybrid cable 70 includes an optical unit 10, a planar cable unit 40, and an external cover (or jacket) 60, which are identical or similar to those of FIG. 2A, except the following differences. The first difference is that the optical fibers 11 of the optical unit 10 are disposed substantially proximate to the planar cable unit 40 and, more particularly, substantially proximate to the conductive paths 51 and/or the base 41 of the planar cable unit 40. The second difference is that at least one of the optical fibers 11 is disposed inside or near the gap 45 formed between the neighboring conductive paths 51. In the figure, the optical fibers 11 are generally thicker than the gaps 45 so that the former 11 sits on the gap 45, without physically touching or contacting the upper surface of the base 41. This arrangement offers the benefits of holding the optical fibers 11 in position, maintaining the relative arrangements between the optical unit 10 and planar cable unit 40, offering a more compact design of the flexible hybrid cable 70 by decreasing the thickness of the flexible hybrid cable 70, and so on.

FIG. 5B shows a cross-sectional view of the second exemplary embodiment of this fifth exemplary aspect of the flexible hybrid cable according to this invention. As shown in the figure, an exemplary flexible hybrid cable 70 includes an optical unit 10, a planar cable unit 40, and an external cover (or jacket) 60, which are identical or similar to those of FIG. 5A, except the optical fibers 11 of the optical unit 10 are disposed substantially in the gap 45 formed between the neighboring conductive paths 51. Accordingly, the optical fibers 11 are generally smaller than the gaps 45 so that the former 11 can sit inside the gap 45 and physically touch the base 41. This arrangement offers the benefits of holding the optical fibers 11 in position, maintaining the relative arrangements between the optical unit 10 and the planar cable unit 40, offering a more compact design of the flexible hybrid cable 70 by decreasing the thickness of the flexible hybrid cable 70, and so on.

As shown in the figure, the conductive paths 51 may have the heights which are greater than the diameters of the optical fibers 11, thereby enclosing such fibers 11 inside the gaps 45. Alternatively, one or some of the conductive paths 51 may have heights which are smaller than the diameters of the optical fibers 11, thereby exposing portions of the optical fibers 11 over the top of the conductive paths 51. When desirable, the conductive paths 51 may have different heights, and the optical fibers 11 of different diameters may be interposed along the planar cable unit 40.

Other configurational and/or operational characteristics and/or benefits of the flexible hybrid cables of FIGS. 5A and 5B are similar or identical to those of the flexible hybrid cables of FIGS. 1A to 1B, FIGS. 2A to 2F, FIGS. 3A to 3F, and FIGS. 4A to 4F. Accordingly, various configurational and/or operational characteristics and/or benefits described in conjunction with the flexible hybrid cables of FIGS. 1A to 1B, FIGS. 2A to 2F, FIGS. 3A to 3F, and FIGS. 4A to 4F can also be incorporated into that of at least one of FIGS. 5A and 5B. Conversely, various configurational and/or operational characteristics and/or benefits described in conjunction with the flexible hybrid cables of FIGS. 5A and 5B can be incorporated to the flexible hybrid cables of FIGS. 1A to 1B, FIGS. 2A to 2F, FIGS. 3A to 3F, and FIGS. 4A to 4F.

FIG. 5C shows a cross-sectional view of the third exemplary embodiment of this fifth exemplary aspect of the flexible hybrid cable according to this invention. As shown in the figure, an exemplary flexible hybrid cable 70 includes an optical unit 10, a planar cable unit 40, and an external cover (or jacket) 60, where at least some of the optical fibers 11 of the optical unit 10 may form one or more bundles and where at least one of such bundles of the optical fibers 11 is interposed between the conductive paths 51. In the embodiment of the figure, three optical fibers 11 form a bundle which is in turn disposed in the gap 45.

As shown in the figure, the bundle of the optical fibers 11 may directly sit inside the gap 45 or, alternatively, the bundle may instead sit over the gap as exemplified in FIG. 5A. The optical fibers 11 of the bundle may be identical to each other or the bundle may include the optical fibers at least two of which may have different diameters, cross-sectional shapes, and so on, at least two of which may be made of or include different materials, and so on. The optical unit 10 may include multiple bundles each of which may include the same or different number of optical fibers.

FIG. 5D shows a cross-sectional view of the fourth exemplary embodiment of this fifth exemplary aspect of the flexible hybrid cable according to this invention. As shown in the figure, an exemplary flexible hybrid cable 70 includes an optical unit 10, a planar cable unit 40, and an external cover (or jacket) 60, where the optical unit 10 includes at least two bundles of the optical fibers 11 and where such bundles are spaced apart by at least one conductive path 51.

As shown in the figure, the bundles of the optical fibers 11 may directly sit inside the gap 45 or, alternatively, at least one of the bundles may instead sit over the gap as exemplified in FIG. 5A. The optical fibers 11 of the bundles may be identical to each other or, alternatively, such bundles may include the optical fibers at least two of which may have different diameters, cross-sectional shapes, and so on, at least two of which may be made of or include different materials, and so on.

Other configurational and/or operational characteristics and/or benefits of the flexible hybrid cables of FIGS. 5C and 5D are similar or identical to those of the flexible hybrid cables of FIGS. 1A to 1B, FIGS. 2A to 2F, FIGS. 3A to 3F, FIGS. 4A to 4F, and FIGS. 5A and 5B.

Accordingly, various configurational and/or operational characteristics and/or benefits described in conjunction with the flexible hybrid cables of FIGS. 1A to 1B, FIGS. 2A to 2F, FIGS. 3A to 3F, FIGS. 4A to 4F, and FIGS. 5A and 5B can also be incorporated into that of at least one of FIGS. 5C and 5D. Conversely, various configurational and/or operational characteristics and/or benefits described in conjunction with the flexible hybrid cables of FIGS. 5C and 5D can be incorporated to the flexible hybrid cables of FIGS. 1A to 1B, FIGS. 2A to 2F, FIGS. 3A to 3F, FIGS. 4A to 4F, and FIGS. 5A and 5B.

FIG. 5E shows a cross-sectional view of the fifth exemplary embodiment of this fifth exemplary aspect of the flexible hybrid cable according to this invention. As shown in the figure, an exemplary flexible hybrid cable 70 includes an optical unit 10, a planar cable unit 40, and an external cover (or jacket) 60, where the optical unit 10 and planar cable unit 40 are both enclosed by the second cover 43 for various purposes such as, e.g., mechanical protection, electrical insulation, and so on.

Although not shown in the figure, at least one of the optical fibers 11 of the optical unit 10 may be enclosed by the first cover as shown in FIGS. 2C, 2D, 2E, 3C, 3D, and 3E, where the second cover 43 may then enclose at least a portion of the planar cable unit 40, enclose at least portions of the optical and planar cable units 10, 40, enclose the entire optical and planar cable units 10, 40, and so on.

Other configurational and/or operational characteristics and/or benefits of the flexible hybrid cable of FIG. 5E are similar or identical to those of the flexible hybrid cables of FIGS. 1A to 1B, FIGS. 2A to 2F, FIGS. 3A to 3F, FIGS. 4A to 4F, and FIGS. 5A to 5D. Accordingly, various configurational and/or operational characteristics and/or benefits described in conjunction with the flexible hybrid cables of FIGS. 1A to 1B, FIGS. 2A to 2F, FIGS. 3A to 3F, FIGS. 4A to 4F, and FIGS. 5A to 5D can also be incorporated into that FIG. 5E. Conversely, various configurational and/or operational characteristics and/or benefits described in conjunction with the flexible hybrid cable of FIG. 5E can be incorporated to the flexible hybrid cables of FIGS. 1A to 1B, FIGS. 2A to 2F, FIGS. 3A to 3F, FIGS. 4A to 4F, and FIGS. 5A to 5D.

FIG. 5F shows a cross-sectional view of the sixth exemplary embodiment of this fifth exemplary aspect of the flexible hybrid cable according to this invention. As shown in the figure, an exemplary flexible hybrid cable 70 includes an optical unit 10, an upper planar cable unit 40A, a lower planar cable unit 40B, and an external cover (or jacket) 60, where the optical unit 10 is disposed in the vertical arrangement in such a way that the optical unit 10 is sandwiched between the pair of planar cable units 40A, 40B.

As exemplified in the figure, the upper and lower planar cable units 40A, 40B may include different number of conductive paths 51 or, alternatively, may include the same number of conductive paths. In addition, the conductive paths 51 of the upper and lower planar cable units 40A, 40B may define the same or different heights or widths, may be made of or include the same or different materials, and the like. Moreover, the gaps 45 formed between the conductive paths 51 of the upper and lower planar cable units 40A, 40B may be disposed (or spaced apart) by the same or different distances, and the like.

Other configurational and/or operational characteristics and/or benefits of the flexible hybrid cable of FIG. 5F are similar or identical to those of the flexible hybrid cables of FIGS. 1A to 1B, FIGS. 2A to 2F, FIGS. 3A to 3F, FIGS. 4A to 4F, and FIGS. 5A to 5E. Accordingly, various configurational and/or operational characteristics and/or benefits described in conjunction with the flexible hybrid cables of FIGS. 1A to 1B, FIGS. 2A to 2F, FIGS. 3A to 3F, FIGS. 4A to 4F, and FIGS. 5A to 5E can also be incorporated into that FIG. 5F. Conversely, various configurational and/or operational characteristics and/or benefits described in conjunction with the flexible hybrid cable of FIG. 5F can be incorporated to the flexible hybrid cables of FIGS. 1A to 1B, FIGS. 2A to 2F, FIGS. 3A to 3F, FIGS. 4A to 4F, and FIGS. 5A to 5E.

In the sixth aspect of the present invention, a flexible hybrid cable may include a single optical unit and multiple planar cable units, may include multiple optical units and a single planar cable unit, or may include multiple optical units and multiple planar cable units. Each of such optical units may include at least one optical fiber, while each of the planar cable units may include at least one electrically conductive path and at least one base or may instead include only at least one base. When the planar cable unit includes multiple conductive paths, such paths defines at least one gap therebetween, where the optical fiber of the optical unit may be disposed above, over, in or on the gap.

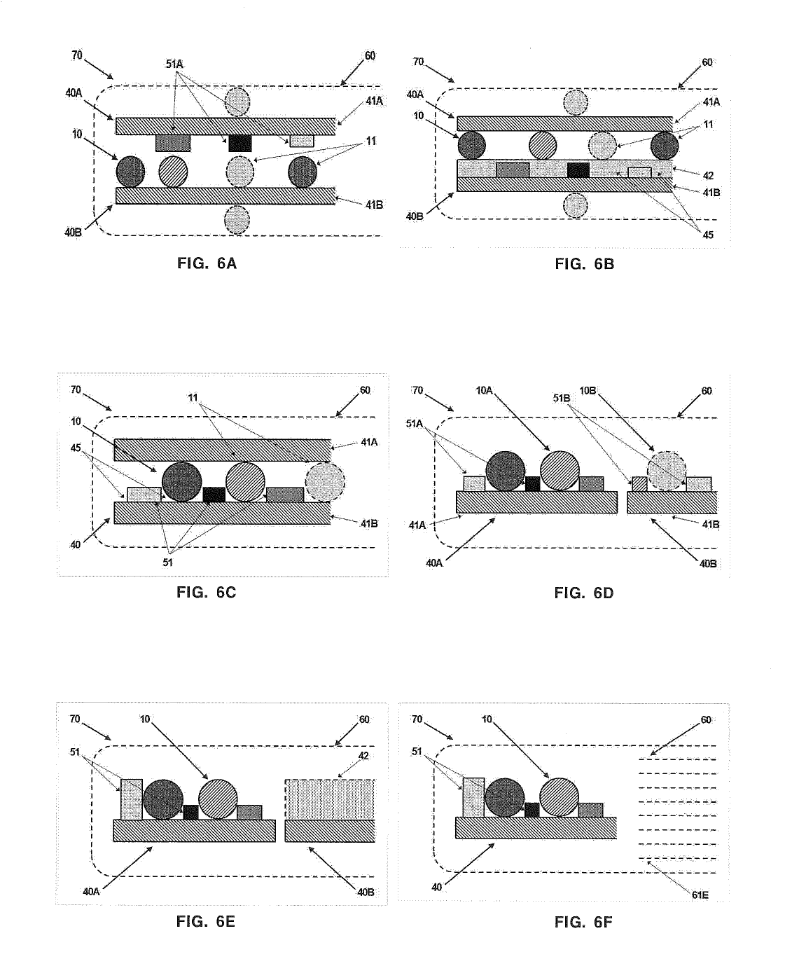

FIG. 6A shows a cross-sectional view of the first exemplary embodiment of this sixth exemplary aspect of the flexible hybrid cable according to this invention. As shown in the figure, an exemplary flexible hybrid cable 70 includes an optical unit 10, an upper planar cable unit 40A, a lower planar cable unit 40B, and an external cover (or jacket) 60, where the optical unit 10 is disposed in the vertical arrangement in such a way that the optical unit 10 is sandwiched between the pair of planar cable units 40A, 40B.

It is noted that the upper planar cable unit 40A includes the upper base 41A and multiple conductive paths 51A, but that the lower planar cable unit 40B only includes the lower base 41B while not including any conductive path. Accordingly, the lower planar cable unit 40B may be deemed to mechanically support of the optical fibers 11 of the optical unit 10, to maintain the arrangement of the optical fibers 11 with respect to the conductive paths 51A of the upper planar cable unit 40A, and so on. It is also noted that the flexible hybrid cable 70 may further include additional optical units which may be disposed on top of the upper base 41A of the upper planar cable unit 40A, below the bottom of the lower base 41B of the lower planar cable unit 40B, and so on. When desirable, the upper planar cable unit 40A may only include the upper base 41A and may not include any conductive path, while the lower planar cable unit 40B may include the lower base 41B and one or more conductive paths provided thereon. In addition, at least one conductive path of the upper planar cable unit may be provided on top of the upper base 41A, at least one conductive path of the lower planar cable unit may be provided under the bottom of the lower base 41B.

FIG. 6B shows a cross-sectional view of the second exemplary embodiment of this sixth exemplary aspect of the flexible hybrid cable according to this invention. As shown in the figure, an exemplary flexible hybrid cable 70 includes a single or multiple optical units 10, an upper planar cable unit 40A, a lower planar cable unit 40B, and an external cover (or jacket) 60, where the optical unit 10 is disposed in the vertical arrangement. This embodiment is generally similar to that of FIG. 6A, except that the lower planar cable unit 40B includes the coating 42 which may cover at least one of multiple conductive paths, may cover at least a portion of the lower base 41B, and so on. When desirable, the coating 42 may be provided not on the base 41B of the lower planar cable unit 40B but on or under the upper base 41A of the upper planar cable unit 40A. Of course both of the upper and lower planar cable units 40A, 40B may include separate coatings or, alternatively, a single layer of such a coating may cover both of the upper and lower planar cable units 40A, 40B.

FIG. 6C shows a cross-sectional view of the third exemplary embodiment of this sixth exemplary aspect of the flexible hybrid cable according to this invention. As shown in the figure, an exemplary flexible hybrid cable 70 includes a single optical unit 10, an upper planar cable unit 40A, a lower planar cable unit 40B, and an external cover (or jacket) 60, where the optical unit 10 is disposed in the vertical arrangement. This embodiment is generally similar to that of FIG. 6A, except that the optical fibers 11 of the optical unit 10 are disposed in the gaps 45 formed between the adjacent conductive paths 51. When desirable, the upper or lower planar cable unit 40A, 40B may include the coating 42 which may cover at least one of multiple conductive paths, may cover at least a portion of the upper or lower base 41A, 41B, and so on.

It is appreciated that the embodiments of FIGS. 6A to 6C offer the benefit of including more optical fibers and/or conductive paths per unit area of the upper or lower base. Accordingly, more data signals and/or non-data signals may be transmitted per unit width or length of the flexible hybrid cable. In addition, these embodiments of FIGS. 6A to 6C may offer the benefit of manufacturing a more compact flexible hybrid cable by incorporating more optical fibers and/or conductive paths into a smaller external cover.

Other configurational and/or operational characteristics and/or benefits of the flexible hybrid cables of FIGS. 6A to 6C are similar or identical to those of the flexible hybrid cables of FIGS. 1A to 1B, FIGS. 2A to 2F, FIGS. 3A to 3F, FIGS. 4A to 4F, and FIGS. 5A to 5F. Accordingly, various configurational and/or operational characteristics and/or benefits described in conjunction with the flexible hybrid cables of FIGS. 1A to 1B, FIGS. 2A to 2F, FIGS. 3A to 3F, FIGS. 4A to 4F, and FIGS. 5A to 5F can also be incorporated into that of at least one of FIGS. 6A to 6C. Conversely, various configurational and/or operational characteristics and/or benefits described in conjunction with each of the flexible hybrid cables of FIGS. 6A to 6C can be incorporated to the flexible hybrid cables of FIGS. 1A to 1B, FIGS. 2A to 2F, FIGS. 3A to 3F, FIGS. 4A to 4F, and FIGS. 5A to 5F.

FIG. 6D shows a cross-sectional view of the fourth exemplary embodiment of this sixth exemplary aspect of the flexible hybrid cable according to this invention. As shown in the figure, an exemplary flexible hybrid cable 70 includes a left optical unit 10A, a right optical unit 10B, a left planar cable unit 40A, a right planar cable unit 40B, and an external cover (or jacket) 60. It is noted that the optical units 10A, 10B are disposed in the lateral arrangement and that the planar cable units 40A, 40B are also disposed in the similar arrangement. On the other hand, the left (or right) optical unit 10A (or 10B) and the left (or right) planar cable unit 40A (or 40B) are disposed in the vertical arrangement in the sense that the optical fibers 11 of the left (or right) optical unit 11A (or 10B) are disposed over or directly on top of the left (or right) conductive paths 51A (or 51B) or the left (or right) base 41A (or 41B).

This embodiment is generally similar to that of FIG. 6C in that the optical fibers 11 of the left and right optical units 10A, 10B are disposed in the gaps 45 formed between the adjacent conductive paths 51A, 51B of the left and right planar cable units 40A, 40B, respectively. However, this embodiment is different from that of FIG. 6C in that multiple optical units 10A, 10B are disposed side by side, and multiple planar cable units 40A, 40B are similarly disposed side by side. When desirable, an additional upper or lower planar cable unit (not shown in the figure) may be placed over the left or right optical unit 10A, 10B. It is noted that each optical unit 10A, 10B may include at least one optical fiber and that the optical units 10A, 10B may include the same or different number of the optical fibers, may include the optical fibers which may include or may be made of the same or different materials, and so on. Similarly, it is noted that each planar cable unit 40A, 40B may include at least one conductive path and that the planar cable units 40A, 40B may include the same or different number of the conductive paths, may include the conductive paths which may include or may be made of the same or different materials, and so on.

Other configurational and/or operational characteristics and/or benefits of the flexible hybrid cable of FIG. 6D are similar or identical to those of the flexible hybrid cables of FIGS. 1A to 1B, FIGS. 2A to 2F, FIGS. 3A to 3F, FIGS. 4A to 4F, FIGS. 5A to 5F, and FIGS. 6A to 6C. Accordingly, various configurational and/or operational characteristics and/or benefits described in conjunction with the flexible hybrid cables of FIGS. 1A to 1B, FIGS. 2A to 2F, FIGS. 3A to 3F, FIGS. 4A to 4F, FIGS. 5A to 5F, and FIGS. 6A to 6C can also be incorporated into that of at least one of FIG. 6D. Conversely, various configurational and/or operational characteristics and/or benefits described in conjunction with each of the flexible hybrid cable of FIG. 6D can be incorporated to the flexible hybrid cables of FIGS. 1A to 1B, FIGS. 2A to 2F, FIGS. 3A to 3F, FIGS. 4A to 4F, FIGS. 5A to 5F, and FIGS. 6A to 6C.

FIG. 6E shows a cross-sectional view of the fifth exemplary embodiment of this sixth exemplary aspect of the flexible hybrid cable according to this invention. As shown in the figure, an exemplary flexible hybrid cable 70 includes an optical unit 10, a left planar cable unit 40A, a right planar cable unit 40B, and an external cover (or jacket) 60. It is noted that the planar cable units 40A, 40B are disposed in the lateral arrangement and that the left planar cable unit 40A include at least one conductive path 51, while the right planar cable unit 40B includes the base but no conductive path. In this sense, the right planar cable unit 40B serves as a filler of the flexible cable 70, thereby allowing proper positioning of the optical unit 10 and the left planar cable unit 40A, providing an area of handling of the flexible hybrid cable 70, thereby providing suitable tensile strength along the axial direction or radial direction, and so on. In the figure, the right planar cable unit 40B typically includes the base and the coating 42. Alternatively, the base of the right planar cable unit 40B may be formed to a desirable thickness which may exceed the thickness of the base of the left planar cable unit 40A, a sum of the thickness of the base and that of multiple conductive paths 51, and so on.

It is noted that the right planar cable unit 40B may be movably positioned inside the external cover 60, thereby allowing the former 40B to slide or move inside the external cover 60. It is also noted that the conductive paths 51 may be provided on the left or right planar cable unit 40A, 40B, and that the optical unit 10 may then be provide on the conductive paths 51 or on the planar cable unit which does not include any conductive path. It is further noted that the flexible hybrid cable 70 may include the optical unit 10 and/or the conductive paths 51 preferentially on its side (e.g., the left end or right end of the figure) or in or near its center.

FIG. 6F shows a cross-sectional view of the sixth exemplary embodiment of this sixth exemplary aspect of the flexible hybrid cable according to this invention. As shown in the figure, an exemplary flexible hybrid cable 70 includes an optical unit 10, a planar cable unit 40, and an external cover (or jacket) 60. The embodiment of FIG. 6F is generally similar to that of FIG. 6E, except that the external cover 60 defines an external filler 61E (i.e., the right side in the figure) which may include or may be made of the same material constituting the external cover 60 or different materials. In this sense, the external filler 61E of the external cover 60 serves as a filler of the flexible cable 70, thereby allowing proper positioning of the optical unit 10 and the planar cable unit 40, providing an area of handling of the flexible hybrid cable 70, and so on. It is noted that the optical and planar cable units 10, 40 may be provided on the left or right side of the flexible hybrid cable 70 (e.g., the left end or right end of the figure) or in or near its center.

Other configurational and/or operational characteristics and/or benefits of the flexible hybrid cables of FIGS. 6E and 6F are similar or identical to those of the flexible hybrid cables of FIGS. 1A to 1B, FIGS. 2A to 2F, FIGS. 3A to 3F, FIGS. 4A to 4F, FIGS. 5A to 5F, and FIGS. 6A to 6D. Accordingly, various configurational and/or operational characteristics and/or benefits described in conjunction with the flexible hybrid cables of FIGS. 1A to 1B, FIGS. 2A to 2F, FIGS. 3A to 3F, FIGS. 4A to 4F, FIGS. 5A to 5F, and FIGS. 6A to 6D can also be incorporated into that of at least one of FIGS. 6E and 6F. Conversely, various configurational and/or operational characteristics and/or benefits described in conjunction with each of the flexible hybrid cables of FIGS. 6E and 6F can be incorporated to the flexible hybrid cables of FIGS. 1A to 1B, FIGS. 2A to 2F, FIGS. 3A to 3F, FIGS. 4A to 4F, FIGS. 5A to 5F, and FIGS. 6A to 6D.

In the seventh aspect of the present invention, a flexible hybrid cable may include a single or multiple optical units and a single or multiple planar cable units, where each of such optical units may include at least one optical fiber, while each of the planar cable units may include at least one electrically conductive path and at least one base or may instead include at least only one base but may not include any conductive path. In addition, such a flexible hybrid cable may also include an external cover which may be made of or include various materials and which may define various heights, widths, diameters or cross-sectional shapes in order to dispose the optical unit(s) or planar cable unit(s) in the desirable position(s) inside the external cover, to dispose the optical unit(s) in a desirable arrangement with respect to the planar cable unit(s), to provide easier handling of the flexible hybrid cable, to provide desirable mechanical flexibility of the flexible hybrid cable, to provide the flexible hybrid cable with the desirable resistance against twisting, bending or other mechanical deformation, and so on.

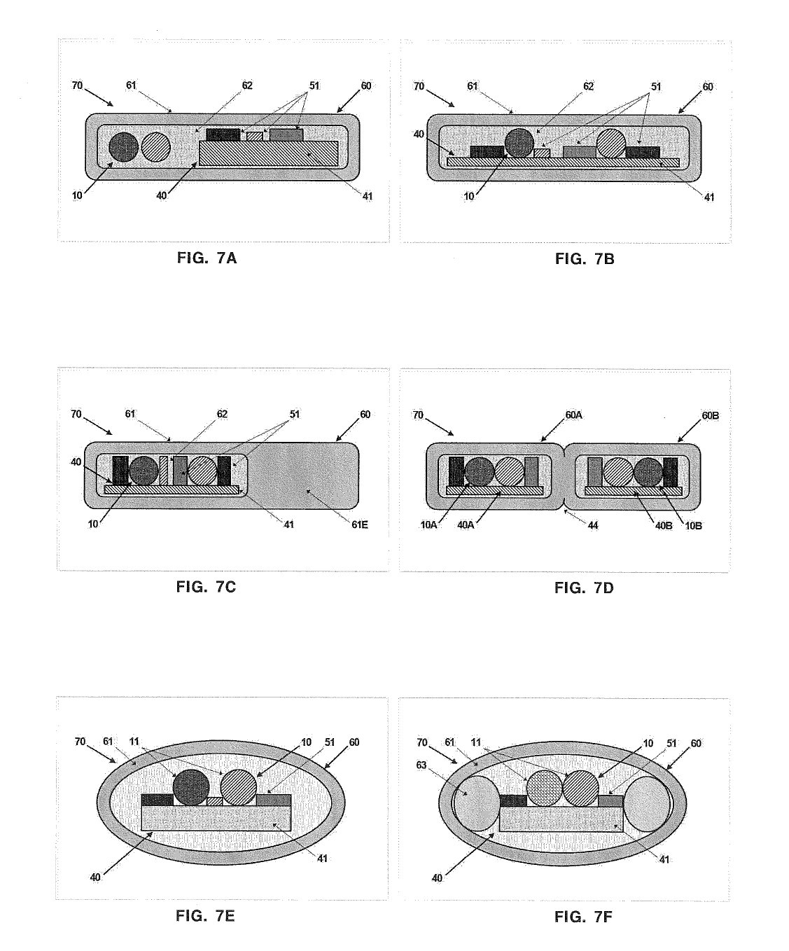

FIG. 7A shows a cross-sectional view of the first exemplary embodiment of this seventh exemplary aspect of the flexible hybrid cable according to this invention. As shown in the figure, an exemplary flexible hybrid cable 70 includes an optical unit 10, a planar cable unit 40, and an external cover (or jacket) 60, where the external cover 60 as well as the flexible hybrid cable 70 is generally flat (i.e., a longer width than a height as shown in the figure) and where the optical unit 10 and the planar cable unit 40 are disposed side by side (i.e., the lateral arrangement) along the width of the external cover 60 or the flexible hybrid cable 70. It is noted that the inside of the external cover 60 may be filled with an optional filler 62 so that the optical unit 10 and the planar cable unit 40 may maintain their relative positions during handling and installing. The filler 62 may be made of or include at least one material capable of absorbing mechanical vibration or shock so that the filler 62 may absorb at least a portion of the mechanical impact applied to the flexible hybrid cable 70. The filler 62 may also be made of or include a material which can minimize EMI in order to minimize undesirable EMI to the transmission of data signals or non-data signals transmitted along the optical fiber 11 or conductive path 51. The external cover 60 may also include an external insulator 61 which provides electrical insulation or optical insulation to the flexible hybrid cable 70.

FIG. 7B shows a cross-sectional view of the second exemplary embodiment of this seventh exemplary aspect of the flexible hybrid cable according to this invention. As shown in the figure, an exemplary flexible hybrid cable 70 includes an optical unit 10, a planar cable unit 40, and an external cover (or jacket) 60 which is similar to that of FIG. 7A. The flexible hybrid cable 70 also includes an insulator 61 and a filler 62 which are similar to those of FIG. 7A. However, the optical fibers 11 of this embodiment are generally positioned over or right on top of the base 41 and in the gaps formed between adjacent conductive paths 51.

FIG. 7C shows a cross-sectional view of the third exemplary embodiment of this seventh exemplary aspect of the flexible hybrid cable according to this invention. As shown in the figure, an exemplary flexible hybrid cable 70 includes an optical unit 10, a planar cable unit 40, and an external cover (or jacket) 60 which is similar to that of FIG. 7A. The flexible hybrid cable 70 also includes an insulator 61 and a filler 62 which are similar to those of FIG. 7A. In addition, the external cover 60 further includes an external filler 61E similar to that of FIG. 6F.

Other configurational and/or operational characteristics and/or benefits of the flexible hybrid cables of FIGS. 7A and 7C are similar or identical to those of the flexible hybrid cables of FIGS. 1A to 1B, FIGS. 2A to 2F, FIGS. 3A to 3F, FIGS. 4A to 4F, FIGS. 5A to 5F, and FIGS. 6A to 6F. Accordingly, various configurational and/or operational characteristics and/or benefits described in conjunction with the flexible hybrid cables of FIGS. 1A to 1B, FIGS. 2A to 2F, FIGS. 3A to 3F, FIGS. 4A to 4F, FIGS. 5A to 5F, and FIGS. 6A to 6F can also be incorporated into that of at least one of FIGS. 7A to 7C. Conversely, various configurational and/or operational characteristics and/or benefits described in conjunction with each of the flexible hybrid cables of FIGS. 7A to 7C can be incorporated to the flexible hybrid cables of FIGS. 1A to 1B, FIGS. 2A to 2F, FIGS. 3A to 3F, FIGS. 4A to 4F, FIGS. 5A to 5F, and FIGS. 6A to 6F.

FIG. 7D shows a cross-sectional view of the fourth exemplary embodiment of this seventh exemplary aspect of the flexible hybrid cable according to this invention. As shown in the figure, an exemplary flexible hybrid cable 70 includes two optical units 10A, 10B, two planar cable units 40A, 40B, and external covers (or jackets) 60A, 60B. More particularly, the external cover forms a pair of lobes 60A, 60B such that the flexible hybrid cable 70 may be deemed to include a pair of sub flexible hybrid cables each of which includes a single optical unit such as 10A or 10B, a single planar cable unit such as 40A or 40B, and the external cover (or jacket) such as 60A or 60B, respectively. In addition, the external covers 60A, 60B are separated by a groove 44 such that the user may easily separate two lobes of the flexible hybrid cable from each other along the groove 44. Accordingly, the user may use the entire flexible cable 70 or, in the alternative, divide such a cable into two identical sub cables and then use each sub cable for different purposes.

The left and right lobes (i.e., the left and right sub flexible hybrid cable) may be fabricated identical to each other such that they include the same number of optical fibers, bases, conductive paths, and so on. When desirable, each lobe may include different number of optical fibers, conductive paths or base, may include different optical fibers, bases or conductive paths. In addition, the left and right lobes may also have the same shapes or sizes or, in the alternative, different shapes, sizes, cross-sectional shapes, and the like.

Other configurational and/or operational characteristics and/or benefits of the flexible hybrid cable of FIG. 7D are similar or identical to those of the flexible hybrid cables of FIGS. 1A to 1B, FIGS. 2A to 2F, FIGS. 3A to 3F, FIGS. 4A to 4F, FIGS. 5A to 5F, FIGS. 6A to 6F, and FIGS. 7A to 7C. Accordingly, various configurational and/or operational characteristics and/or benefits described in conjunction with the flexible hybrid cables of FIGS. 1A to 1B, FIGS. 2A to 2F, FIGS. 3A to 3F, FIGS. 4A to 4F, FIGS. 5A to 5F, FIGS. 6A to 6F, and FIGS. 7A to 7C can also be incorporated into that of FIG. 7D. Conversely, various configurational and/or operational characteristics and/or benefits described in conjunction with each of the flexible hybrid cable of FIG. 7D can be incorporated to the flexible hybrid cables of FIGS. 1A to 1B, FIGS. 2A to 2F, FIGS. 3A to 3F, FIGS. 4A to 4F, FIGS. 5A to 5F, FIGS. 6A to 6F, and FIGS. 7A to 7C.

FIG. 7E shows a cross-sectional view of the fifth exemplary embodiment of this seventh exemplary aspect of the flexible hybrid cable according to this invention. As shown in the figure, an exemplary flexible hybrid cable 70 includes an optical unit 10, a planar cable unit 40, and an external cover (or jacket) 60. In general, the optical and planar cable units 10, 40 of this embodiment are similar to those of FIG. 7B, whereas the external cover 60 defines a generally circular or oval cross-section.

FIG. 7F shows a cross-sectional view of the sixth exemplary embodiment of this seventh exemplary aspect of the flexible hybrid cable according to this invention. As shown in the figure, an exemplary flexible hybrid cable 70 includes an optical unit 10, a planar cable unit 40, and an external cover (or jacket) 60. In general, the optical and planar cable units 10, 40 of this embodiment are similar to those of FIG. 7E, except that the flexible hybrid cable 70 further includes at least one spacer 63 which are disposed inside the external cover 60 to provide mechanical protection to the optical or planar cable unit 10, 40, to maintain relative positions of such units 10, 40, and the like.

Other configurational and/or operational characteristics and/or benefits of the flexible hybrid cables of FIGS. 7E and 7F are similar or identical to those of the flexible hybrid cables of FIGS. 1A to 1B, FIGS. 2A to 2F, FIGS. 3A to 3F, FIGS. 4A to 4F, FIGS. 5A to 5F, FIGS. 6A to 6F, and FIGS. 7A to 7D. Accordingly, various configurational and/or operational characteristics and/or benefits described in conjunction with the flexible hybrid cables of FIGS. 1A to 1B, FIGS. 2A to 2F, FIGS. 3A to 3F, FIGS. 4A to 4F, FIGS. 5A to 5F, FIGS. 6A to 6F, and FIGS. 7A to 7D can also be incorporated into at least one of such cables of FIGS. 7E and 7F. Conversely, various configurational and/or operational characteristics and/or benefits described in conjunction with each of the flexible hybrid cables of FIGS. 7E and 7F can be incorporated to the flexible hybrid cables of FIGS. 1A to 1B, FIGS. 2A to 2F, FIGS. 3A to 3F, FIGS. 4A to 4F, FIGS. 5A to 5F, FIGS. 6A to 6F, and FIGS. 7A to 7D.

Configurational and/or operational variations and/or modifications of the above embodiments and/or aspects of the exemplary flexible hybrid cables and methods of manufacturing and using such flexible hybrid cables of the present invention also fall within the scope of this invention

The flexible hybrid cables of this invention may include various numbers of the optical fibers and/or optical units, various number of the conductive paths and/or planar cable units, and so on. In addition, the positions of such optical fibers and/or optical unit(s), and those of the conductive paths and/or planar cable unit(s) may be modified as one of ordinary skill in the art may see fit. In addition, as long as the flexible hybrid cables can provide desirable flexibility, the shape and size of the external cover and its cross-sectional shape is not generally material within the scope of the present invention.

The flexible hybrid cables of this invention may include the optical fibers of various types and configurations and may also include the conductive paths of various types and configurations as long as such cables may transmit desirable amount of data signals and non-data signals per unit cross-sectional area of such cables. Of course at least a portion of such cables are occupied by the external cover, fillers, insulators or void. Accordingly, the flexible hybrid cables may be shaped and sized to meet various design needs.

In one example, the flexible hybrid cable may be made as compact as possible when the design criteria are focused on the size of such a cable. Accordingly, the optical fibers and conductive paths may be disposed as closely as possible in order to maximize the first cross-sectional area of the optical fibers and the second cross-sectional area of the conductive paths per a unit cross-sectional area of the flexible hybrid cable. Depending upon the materials used to fabricate the optical unit and the planar cable unit, this embodiment may also offer the benefit of optimizing the flexibility of the flexible hybrid cable.

It is appreciated, however, that the compact flexible hybrid cable may need a special connector to connect such a flexible hybrid cable to a connector or to another compact flexible hybrid cable. Accordingly and in another example, the flexible hybrid cable may be fabricated to have a volume beyond a certain threshold value when the design criteria are focused on easier handling of such a cable. For example, the optical fibers may be spaced apart from each other at certain distances to more easily connect such fibers to a connector, to more easily handle each optical fiber, and so on. Likewise, the conductive paths may be spaced apart from each other at certain distances for easier handling, connections, and so on. When desirable, the optical unit may preferentially include plastic optical fibers which are generally thicker than glass optical fibers in order to facilitate easier handling and connections, and so on.

The flexible hybrid cables of this invention may include various planar cable units each of which may include various bases of which shapes, sizes, and cross-sections may vary as one of ordinary skill in the art may see fit. In one example, the base may be made of or include at least minimally flexible materials so that the planar cable units also exhibit at least minimum flexibility. In another example the base may be made of or include relatively rigid materials but may include small pieces at least minimally movably coupled to each other so that the base as a whole may exhibit minimum flexibility. Such bases may be made flat, while defining uniform thicknesses or thicknesses varying across lengths or widths of the bases. Alternatively, such bases may be made curved, while defining uniform thicknesses or thicknesses varying across lengths or widths of the bases.

It is appreciated that the aforementioned optional external filler or optional spacer may be made of or may include various materials, and may be provided in various shapes and/or sizes. Accordingly, a conventional electric wire or a plastic wire can be used as the filler or spacer, where the former may offer the benefit of utilizing such for transmitting the non-data signals when desirable.

Various flexible hybrid cables of the present invention may be fabricated in various shapes, sizes, and configurations to serve various goals.

For example, a HDMI cable such as, e.g., a high-speed HDMI A-A type active optical cable which is manufactured by Unive, Inc. (48389 Fremont Boulevard., Suite 106, Fremont, Calif. 94538), typically includes four optical fibers and six AWG28 copper wires (0.33 mm diameter). Such a conventional HDMI cable can be easily converted into an exemplary flexible hybrid cable of the present invention by incorporating the same number of optical fibers and an exemplary planar cable unit which in turn includes therein six electrically conductive paths based on an “area matching.” In other words, each of the conductive paths of the planar cable unit may define a cross-sectional area of about 0.085 mm² which is equivalent to the cross-sectional area of the AWG28 copper wire of the UHO. In other words, each conductive path of the exemplary flexible hybrid cable may have a height and a width as long as the product of such a height and width yields the cross-sectional area of from about 0.08 mm² to about 0.09 mm². Accordingly, such paths may define a height of 0.105 mm and a width of 0.765 mm, while each of the paths may be spaced away by a few tenth of a millimeter such as, e.g., 0.2 mm, 0.3 mm, 0.4 mm, and so on.

In addition and as described in FIGS. 1 to 7, the planar cable unit may define six conductive paths which are placed on one surface thereof. Alternatively, the planar cable unit may include two, three or four electrically conductive paths on a top surface thereof, while defining the remaining four, three or two paths on its bottom surface, respectively. As shown in the above figures, six electrically conductive paths may have the same height and width or, in the alternative, at least one of such paths may define a height or width which is different from that of the remaining conductive paths. In other words, as long as each electrically conductive path can transmit as much non-data signals as each copper wire of the conventional cable does, the exact shape and size of the conductive paths of the flexible hybrid cable is not material.

Furthermore, the substrate of the planar cable unit may also be provided in various shapes, sizes, and materials. For example, a polyimide-based substrate (such as, e.g., Pyralux AC and AP series) manufactured by Du Pont (Concord Plaza, Wilmington, Del.) has a thickness from about 0.012 mm to about 0.045 mm. Of course other manufacturers produce various dielectric substrates with different thicknesses. Accordingly, the user can select the substrate with a suitable thickness.

Unless otherwise specified, various features of a certain embodiment of a certain aspect of the present invention may apply interchangeably to other embodiments of the same aspect of this invention and/or embodiments of one or more of other aspects of this invention. For example, any optical unit of various embodiments described hereinabove may be replaced by the optical units of FIGS. 2C to 2E so that at least one optical fiber of the optical unit may be enclosed by the first cover. Similarly, any planar cable unit of various embodiments described hereinabove may be replaced by the planar cable units of FIGS. 2B, 2D, and 2F so that at least one conductive path of the planar cable unit may be enclosed by the second cover.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. A flexible hybrid cable comprising:
at least one optical unit which includes at least one optical fiber and which transmits an optical signal along said fiber;
at least one planar cable unit which includes at least one flexible planar substrate and at least one electrically conductive path disposed on said substrate and which transmits an electrical signal along said conductive path; and
at least one external cover which encompasses said optical unit and planar cable unit therein.

2. The flexible hybrid cable of claim 1, wherein said planar cable unit defines an elongated cross-sectional shape and wherein said cable also has an elongated cross-section which in turn defines a short axis and a long axis.

3. The flexible hybrid cable of claim 2, wherein a ratio of said short axis to said long axis is less than one of 0.9, 0.8, 0.7, 0.6, 0.5, 0.4, 0.3, 0.2, and 0.1.

4. The flexible hybrid cable of claim 3, wherein said optical unit and said planar cable unit are disposed at least partly laterally along said long axis.

5. The flexible hybrid cable of claim 3, wherein said optical unit is at least partly stacked one of over and below said planar cable unit along said short axis.

6. The flexible hybrid cable of claim 1, wherein said cable is flexible enough to define a minimum bend diameter of about 20 times a diameter of said optical fiber while not damaging transmission ability of said optical fiber by about 10%.

7. The flexible hybrid cable of claim 6, wherein said minimum bend diameter is one of 10 mm, 7 mm, 5 mm, 4 mm, 3 mm, and 2 mm, while not decreasing transmission ability of the optical fiber by about 10%.

8. The flexible hybrid cable of claim 1, wherein said planar cable unit includes at least one of a single-sided planar cable, a double-access cable, a back bared planar cable, a sculptured planar cable, a double-sided planar cable, a multilayer planar cable, a rigid-flexible cable, and a polymer film cable.

9. The flexible hybrid cable of claim 1 further comprising at least one of:
a first coating disposed on top of said conductive path and one of mechanically and electrically protecting said path; and
a second coating disposed on a side of said conductive path and one of mechanically and electrically protecting said path.

10. The flexible hybrid cable of claim 1 further comprising at least one of:
a first cover enclosing therein at least a portion of said optical unit;
a second cover enclosing therein at least a portion of said planar cable unit;
a first coupling unit coupling said optical unit to said planar cable unit;
a second coupling unit coupling said first cover to said planar cable unit; and
a third coupling unit coupling said second cover to said optical unit.

11. The flexible hybrid cable of claim 1 further comprising at least one of:
a first insulator disposed between two electrically conductive paths for providing electrical insulation therebetween;
a second insulator disposed between two planar cable units for providing electrical insulation therebetween;
a third insulator disposed between said optical unit and said planar cable unit for providing electrical insulation to said planar cable unit;
a first external filler to mechanically protect one of said optical unit and said planar cable unit;
a second external filler to protect said planar cable unit from electromagnetic interference; and
a third external filler to maintain an elongated shape of said cable.

12. A flexible hybrid cable defining an elongated cross-section comprising:
a plurality of optical fibers each capable of transmitting an optical signal therealong;
at least one planar cable unit which includes at least one substrate and at least one electrically conductive path; and
at least one external cover which encompasses said optical fibers and planar cable unit therein,
wherein said substrate is flexible and defines an elongated cross-section,
wherein said electrically conductive path is disposed on said substrate and transmits an electrical signal therealong, and
wherein said optical fibers are arranged inside said external cover while maintaining said elongated cross-section of said cable.

13. The flexible hybrid cable of claim 12, wherein said cross-section of said cable defines a short axis and a long axis and wherein a ratio of said short axis to said long axis is less than one of 0.9, 0.8, 0.7, 0.6, 0.5, 0.4, 0.3, 0.2, and 0.1.

14. The flexible hybrid cable of claim 12, wherein said planar cable unit includes at least one of a single-sided planar cable, a double-access cable, a back bared planar cable, a sculptured planar cable, a double-sided planar cable, a multilayer planar cable, a rigid-flexible cable, and a polymer film cable.

15. The flexible hybrid cable of claim 12, wherein said substrate includes a polymeric compound which is at least one of polyimide, polyester, polyethylene napthalate, polyetherimide, polyether ether ketone, polyethylene terephthalate, various fluoro-polymers, and epoxy.

16. A method of transmitting a high-bandwidth signal and a low-bandwidth signal through a single cable while providing enhanced mechanical flexibility and flat structure to said cable comprising the steps of:
optically transmitting said high-bandwidth signal along at least one flexible optical fiber included in said cable;
forming at least one electrically conductive path on a planar and flexible substrate included in said cable; and
electrically transmitting said low-bandwidth signal along said conductive path,
thereby maintaining said flexibility of said cable and maintaining an elongated cross-section of said cable at least partly due to said flat structure of said substrate.

17. The method of claim 16, wherein said cross-section of said cable defines a short axis and a long axis and wherein said maintaining said cross-section of said cable includes at least one of the step of:
maintaining a ratio of said short axis to said long axis less than 0.9;
maintaining a ratio of said short axis to said long axis less than 0.7;
maintaining a ratio of said short axis to said long axis less than 0.5;
maintaining a ratio of said short axis to said long axis less than 0.3; and
maintaining a ratio of said short axis to said long axis less than 0.1.

18. The method of claim 16 further comprising at least one of the steps of:
disposing said optical unit and planar cable unit at least partly laterally along said long axis;
disposing an entire portion said optical unit and an entire portion of said planar cable unit on different ends of said cable along said long axis;
disposing at least a portion of said optical unit one of over and above at least a portion of said planar cable unit;
disposing at least a portion of said optical unit one of under and below at least a portion of said planar cable unit;
at least partly stacking said optical unit one of over and below said planar cable unit along said short axis;
stacking an entire portion of optical unit one of over and above said planar cable unit;
stacking an entire portion of optical unit one of under and below said planar cable unit;
stacking at least a portion of said optical unit one of not directly over and not directly below said planar cable unit; and
stacking at least a portion of said planar cable unit one of not directly over and not directly below said optical unit.

19. The method of claim 16, wherein said forming said electrically conductive path is one of:
forming a single-sided planar cable;
forming a double-access cable;
forming a back bared planar cable;
forming a sculptured planar cable;
forming a double-sided planar cable;
forming a multilayer planar cable;
forming a rigid-flexible cable; and
forming a polymer film cable.

20. The method of claim 16 further comprising one of the steps of:
filling at least a portion of an interior of said cable for mechanical protection of at least one of said optical fiber, substrate, and conductive path;
filling at least a portion of said interior of said cable to protect said path from electromagnetic interference; and
filling at least a portion of said interior of said cable to maintain said elongated cross-section of said cable.
